(19) United States
(12) Patent Application Publication
(10) Pub. No.: US 2002/0135624 A1
(43) Pub. Date: Sep. 26, 2002

(54) Coloring agent amount recording apparatus, coloring agent materials cost processing apparatus, coloring agent cartridge, and collection of the cartridge

(75) Inventors: Takahiro Naka, Nagano-ken (JP); Masumi Yoshino, Nagano-ken (JP); Hideto Matsuzaka, Nagano-ken (JP); Eiko Yanagida, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/092,616

(22) Filed: Mar. 8, 2002

Related U.S. Application Data
(63) Continuation of application No. PCT/JP01/05959, filed on Jul. 10, 2001.

(30) Foreign Application Priority Data
Jul. 11, 2000 (JP) 2000-210162
Sep. 4, 2000 (JP) 2000-267067

(51) Int. Cl. B41J 2/195

(52) U.S. Cl. 347/7

(57) ABSTRACT

When a printer carries out maintenance by control by a maintenance control portion 52, an ink information obtaining portion 73 calculates the amount of the consumed ink. The calculated ink amount is stored in a storage element attached to an ink cartridge by a storage element managing portion 74. By doing this, the amount of ink not used in actual printing such as the amount of ink used for maintenance can be grasped by reading out the contents of the storage element later.

### CROSS-REFERENCE TO RELATED APPLICATION

This is a continuation of Application PCT/JP01/05959, filed Jul. 10, 2001, now abandoned.

### BACKGROUND OF THE INVENTION

1. Field of the Invention

The present invention relates to a technology to make a refund to a user according to the amount of printing coloring agent not used in actual printing.

2. Description of the Prior Art

For ink jet printers capable of color printing, an ink cartridge comprising a plurality of bottles integrated with one another is sometimes used for housing inks of a plurality of colors. In ink cartridges of this type, when the ink of at least one of the colors runs out, color printing cannot be carried out even if the inks of the other colors remain.

Moreover, printers require occasional maintenance. For example, in the case of ink jet printers, when the nozzle is clogged, the print head is cleaned. This cleaning consumes ink in the ink cartridge.

Users who purchase ink cartridges want to carry out printing with the least wasted ink. Therefore, users are greatly dissatisfied with the ink that remains unused or the ink consumed for maintenance as mentioned above.

### SUMMARY OF THE INVENTION

Under such circumstances, if a refund can be made to users who purchased ink cartridges according to the amounts that cannot be used for printing, user dissatisfaction will be resolved, which will improve customer satisfaction. An object of the present invention is to provide a technology to make a refund to a user according to the amount of printing coloring agent that cannot be used for printing.

A coloring agent amount recording apparatus of the present invention comprises: an information obtaining portion obtaining information on an amount of a printing coloring agent not used in actual printing; and an information writing portion writing onto a recording medium the information on the amount obtained by the information obtaining portion.

In this coloring agent amount recording apparatus, the information on the amount of the printing coloring agent not used in actual printing is written onto the recording medium. In this way, the amount of the printing coloring agent not used in actual printing can be grasped by reading out the contents of the recording medium later. This apparatus is applicable to any apparatus, for example, to printers, cash registers, Web servers, coloring agent collecting apparatuses and apparatuses specifically designed for recording the coloring agent amount. Moreover, this apparatus may be housed in a case, or may be a system comprising a plurality of apparatuses.

In the coloring agent amount recording apparatus of the present invention, the recording medium may be attached to a cartridge containing the printing coloring agent. In this way, when the contents of the recording medium are read out later, it can be clarified to which cartridge the contents correspond.

In the coloring agent amount recording apparatus of the present invention, although the printing coloring agent is not specifically limited as long as it is a coloring agent for printing, examples thereof include ink and toner. Of these, ink is preferable.

In the coloring agent amount recording apparatus of the present invention, preferably, the amount not used in actual printing includes a residual amount of the printing coloring agent. Although it is a cause of user dissatisfaction that the printing coloring agent cannot be completely used and some remains unused, according to this invention since the residual amount can be grasped, arrangements to resolve user dissatisfaction can be taken. The residual amount may be obtained either directly or indirectly. When it is obtained indirectly, it may be obtained, for example, by measuring the amount used in actual printing and subtracting the amount from the initial amount.

In the coloring agent amount recording apparatus of the present invention, preferably, the amount not used in actual printing includes an amount of the printing coloring agent used for maintenance of a printing mechanism. Although it is a cause of user dissatisfaction that the amount of the printing coloring agent is reduced at the time of maintenance although no actual printing is carried out, according to this invention since the amount used at the time of maintenance can be grasped, arrangements to resolve user dissatisfaction can be taken.

In the coloring agent amount recording apparatus of the present invention, the information obtaining portion may obtain the information on the amount not used in actual printing for each of the colors of the printing coloring agent, and the information writing portion may write onto the recording medium the information of each of the colors obtained by the information obtaining portion. In this way, although there are cases where when the time to replace coloring agents for color printing arrives, the consumption amounts of the coloring agents of the colors vary according to the use histories thereof, these situations can be grasped.

The coloring agent amount recording apparatus of the present invention may be a part of a printing apparatus carrying out printing with the printing coloring agent. In this way, it is possible to obtain the amount not used in actual printing through the printing mechanism every time printing is carried out and write the amount onto the recording medium.

The coloring agent materials cost processing apparatus of the present invention comprises: an information reading portion reading out information on an amount of a printing coloring agent not used in actual printing from a recording medium on which the information on the amount is written; and a materials cost generating portion generating a materials cost of the amount based on the information on the amount read out by the information reading portion.

In this coloring agent materials cost processing apparatus, the information on the amount of the printing coloring agent not used in actual printing is read out from the recording medium, and the materials cost, or the proprietary nature, of the amount is generated based on the information on the amount. Here, the “actual printing” means printing onto a printing medium such as paper, and the “information on the amount not used in actual printing” includes not only the amount not used in actual printing but also parameters from which the amount can be calculated (for example, with respect to the residual amount, the initial capacity and the capacity used in actual printing). Regardless that the amount of the printing coloring agent is reduced although no actual printing is carried out and that the printing coloring agent cannot be completely used and some remains unused are causes of user dissatisfaction, according to this coloring agent materials cost processing apparatus, since the materials cost of the amount not used in actual printing is generated based on the information on the amount, the maker or the dealer can refund the materials cost to the user, so that user dissatisfaction can be resolved. This apparatus may be housed in a case, or may be a system comprising a plurality of apparatuses.

In the coloring agent materials cost processing apparatus of the present invention, the materials cost generating portion may write onto the recording medium information representing that materials cost processing has been completed when the materials cost is refunded to a user. In this way, there is no possibility that the same information is read out from one recording medium more than once, so that there is no possibility that the materials cost is paid more than once.

The coloring agent materials cost processing apparatus of the present invention may further comprise a materials cost recording portion recording the materials cost generated by the materials cost generating portion onto a predetermined target of recording. In this way, after the information on the amount is readout from the recording medium and the materials cost of the amount is recorded onto the predetermined target of recording based on the information, the original recording medium can be recycled. Moreover, by reading out the materials cost recorded on the target of recording at an appropriate time, the materials cost can be refunded to the user.

In the mode provided with the materials cost recording portion, the materials cost recording portion may record the materials cost onto the target of recording so as to be associated with a user. In this way, confirmation of the user and the amount of materials cost can be made later.

Moreover, in the mode provided with the materials cost recording portion, the materials cost recording portion may record the materials cost onto the target of recording so as to be accumulated. In this way, the user can save on the materials cost.

Moreover, in the mode provided with the materials cost recording portion, the materials cost recording portion may write onto the recording medium information representing that materials cost processing has been completed when the materials cost is recorded onto the target of recording. In this way, there is no possibility that the same information is read out from one recording medium more than once, so that there is no possibility that the materials cost is paid more than once.

Further, in the mode provided with the materials cost recording portion, the target of recording may be a portable card-type memory. In this way, the user can carry the card-type memory with him and have the materials cost recorded on the card-type memory when necessary.

Further, in the mode provided with the materials cost recording portion, the storage content of the target of recording may be accessible by a user through a network. In this way, the user can easily find the materials cost by accessing the content when the user wants to know the materials cost that the user has.

In the coloring agent materials cost processing apparatus of the present invention, the recording medium may be attached to a coloring agent cartridge containing the printing coloring agent. In this way, when the contents of the recording medium are read out later, it can be clarified to which cartridge the contents correspond. Moreover, although the printing coloring agent is not specifically limited as long as it is a coloring agent for printing, examples thereof include ink and toner. Of these, ink is preferable.

In the coloring agent materials cost processing apparatus of the present invention, preferably, the amount not used in actual printing includes a residual amount of the printing coloring agent. Although it is a cause of user dissatisfaction that the printing coloring agent cannot be completely used and some remains unused, according to this apparatus, since the materials cost is generated based on the information on the residual amount of the printing coloring agent, the maker or the dealer can refund the materials cost to the user, so that user dissatisfaction can be resolved.

Moreover, preferably, the amount not used in actual printing includes an amount of the printing coloring agent used for maintenance of a printing mechanism. Although it is a cause of user dissatisfaction that the amount of the printing coloring agent is reduced at the time of maintenance although no actual printing is carried out, according to this apparatus, since the materials cost is generated based on the information on the amount used at the time of maintenance, the maker or the dealer can refund the materials cost to the user, so that user dissatisfaction can be resolved.

In the coloring agent materials cost processing apparatus of the present invention, the materials cost may be a bonus to the user. The bonus may be, for example, points analogous to cash (including trading stamps and stickers as well as the number of points), a voucher (including a coupon ticket), a discount that the user receives when making a purchase, a discount that the user receives when receiving a service, cash back, or goods.

In the coloring agent materials cost processing apparatus of the present invention, the information reading portion may read out, from a recording medium on which the information on the amount of the printing coloring agent not used in actual printing is written for each of the colors, the information on the amount of each of the colors, and the materials cost generating portion may generate the materials cost based on the information on the amount of each of the colors read out by the information reading portion. In this way, although there are cases where when the time to replace coloring agents for color printing arrives, the consumption amounts of the coloring agents of the colors vary according to the use histories thereof, these situations can be grasped so that the materials cost is appropriately obtained according to the amount of the coloring agent of each color.

The coloring agent cartridge of the present invention is a coloring agent cartridge containing a printing coloring agent, said cartridge comprising a recording medium on which information on an amount of the printing coloring agent not used in actual printing is recorded. In this way, since the information on the amount is read out from the recording medium provided in the coloring agent cartridge, it can be clarified to which cartridge the information corresponds.

The coloring agent cartridge collecting apparatus of the present invention comprises the coloring agent materials cost processing apparatus and the cartridge storage portion for collecting a coloring agent cartridge containing the printing coloring agent. In this way, since when a used coloring agent cartridge is collected, the information on the amount of the printing coloring agent in the coloring agent cartridge not used in actual printing is read out and the materials cost of the amount is generated, the materials cost can be refunded to the user. Consequently, users will willingly return used coloring agent cartridges, so that the rate of returned used cartridges increases to improve recycling. This apparatus may be housed in a case, or may be a system comprising a plurality of apparatuses.

The cartridge collecting method of the present invention is a method for collecting a coloring agent cartridge containing a printing coloring agent, said method comprising the step of: (a) obtaining information on an amount of the printing coloring agent in the coloring agent cartridge, not used in actual printing; and (b) generating a materials cost of the amount based on information on the amount. In this way, since when a used coloring agent cartridge is collected, the information on the amount of the printing coloring agent in the coloring agent cartridge not used in actual printing is read out and the materials cost of the amount is generated, the materials cost can be refunded to the user. Consequently, users will willingly return used coloring agent cartridges, so that the rate of returned used cartridges increases to improve recycling.

The transportation body for collection of the present invention is equipped with a coloring agent cartridge collecting apparatus. It is possible to visit users' homes for collecting used coloring agent cartridges with this transportation body for collection, for example, a vehicle such as a truck, in response to the users' requests and generate the materials cost at the site. Since the transportation body for collection is equipped with the coloring agent cartridge collecting apparatus, used coloring agent cartridges can be collected without the users' bringing them to stores or sending them to makers, so that customer convenience improves. Makers carrying out the collection can entrust the collection to a package delivery company.

The user interface of the present invention is a user interface used when a coloring agent cartridge containing a printing coloring agent is collected, said user interface comprising: an identification information display portion for displaying identification information for identifying a user; a materials cost display portion displaying a materials cost of an amount of the printing coloring agent not used in actual printing based on information on the amount; and a materials cost accumulated total display portion displaying an accumulated total of the materials cost associated with the identification information. In this way, the identification information for identifying the user returning a used coloring agent cartridge can be easily input or output, and the user can easily find the materials cost of the amount of the printing coloring agent in the coloring agent cartridge not used in actual printing and the user's accumulative total of materials cost. This may be an interface specifically designed therefor or may be a display on a personal computer. As the “identification information,” a so-called registered user ID, the name, the date of birth, the address, the telephone number or the like may be used.

The present invention is applicable to the fields of technologies associated with printing coloring agents, for example, in the fields of printers, facsimiles and copiers, to encourage users to cooperate in recycling of printing coloring agents and containers containing printing coloring agents by making a refund to users according to the amount of the printing coloring agent not used in actual printing.

### BRIEF DESCRIPTION OF THE DRAWINGS

FIG. 1 is an explanatory view showing the hardware structure of a printing system according to a first embodiment;

FIG. 2 is an explanatory view showing the appearance of an ink cartridge used for a printer in the first embodiment;

FIG. 3 is an explanatory view showing the functional structure of the printing system according to the first embodiment;

FIG. 4(a) is an explanatory view schematically showing a head cleaning mechanism in the first embodiment;

FIG. 4(b) is an explanatory view showing a nozzle surface of a print head in the first embodiment;

FIG. 5 is an explanatory view showing an example of a utility selection screen in the first embodiment;

FIG. 6 is an explanatory view showing an example of the data structure of ink amount information in the printing system according to the first embodiment;

FIG. 7 is an explanatory view showing the hardware structure of a sales managing system according to a second embodiment;

FIG. 8 is an explanatory view showing the functional structure of the sales managing system according to the second embodiment;

FIG. 9(a) and FIG. 9(b) are explanatory views each showing an example of a discount display screen in the second embodiment;

FIG. 10 is an external view of a residual ink materials cost refunding apparatus according to a third embodiment;

FIG. 11 is an explanatory view showing an ink cartridge attached to a cartridge attachment portion according to the third embodiment;

FIG. 12 is an explanatory view showing the internal structure of the residual ink materials cost refunding apparatus according to the third embodiment;

FIG. 13 is a flowchart showing the action of the residual ink materials cost refunding apparatus according to the third embodiment;

FIG. 14 is an explanatory view showing a point card used for the residual ink materials cost refunding apparatus according to the third embodiment, and information recorded on the point card;

FIG. 15 is an external view of a residual ink materials cost refunding apparatus according to a fourth embodiment;

FIG. 16 is an explanatory view showing the internal structure of the residual ink materials cost refunding apparatus according to the fourth embodiment;

FIG. 17 is a flowchart showing the action of the residual ink materials cost refunding apparatus according to the fourth embodiment;

FIG. 18 is an external view of a residual ink materials cost refunding system according to a fifth embodiment;

FIG. 19 is an explanatory view showing the internal structures of the residual ink materials cost refunding apparatus and a cash register according to the fifth embodiment;

FIG. 20 is a flowchart showing the action of the residual ink materials cost refunding apparatus according to the fifth embodiment;

FIG. 21 is a flowchart showing the action of the cash register according to the fifth embodiment;

FIG. 22 is an explanatory view showing a condition before a cartridge is set in a cartridge collecting apparatus with a materials cost refunding function according to a sixth embodiment;

FIG. 23 is an explanatory view showing a condition where a cartridge is set in the cartridge collecting apparatus with a materials cost refunding function according to the sixth embodiment;

FIG. 24 is an explanatory view showing a condition where a shutter of a first collection box is opened in the cartridge collecting apparatus with a materials cost refunding function according to the sixth embodiment;

FIG. 25 is an explanatory view showing a condition where a cartridge collecting processing is completed on a display portion in the cartridge collecting apparatus with a materials cost refunding function according to the sixth embodiment;

FIG. 26 is an explanatory view showing the internal structure of the cartridge collecting apparatus with a materials cost refunding function according to the sixth embodiment;

FIG. 27 is a flowchart of apart of the cartridge collecting processing according to the sixth embodiment;

FIG. 28 is a flowchart of the remaining part of the cartridge collecting processing according to the sixth embodiment;

FIG. 29 is an explanatory view showing a modification using a bar code instead of an IC memory in the sixth embodiment;

FIG. 30 is a block diagram showing the structure of an ink cartridge collecting system according to a seventh embodiment;

FIG. 31 is an explanatory view showing a point storage table according to a seventh embodiment;

FIG. 32(A) and FIG. 32(B) are explanatory views of a color ink cartridge according to the seventh embodiment;

FIG. 33 is an explanatory view showing the data arrangement of a storage element provided in the color ink cartridge according to the seventh embodiment;

FIG. 34 is a flowchart of detection of the residual amount of ink of the color ink cartridge and point exchange according to the seventh embodiment;

FIG. 35 is an explanatory view showing an example of the flow of point information browsing and point exchange according to the seventh embodiment; and

FIG. 36 is a block diagram showing the structure of an ink cartridge collecting system according to an eighth embodiment.

### DESCRIPTION OF THE PREFERRED EMBODIMENTS

Next, preferred embodiments of the present invention will be described.

[First Embodiment]

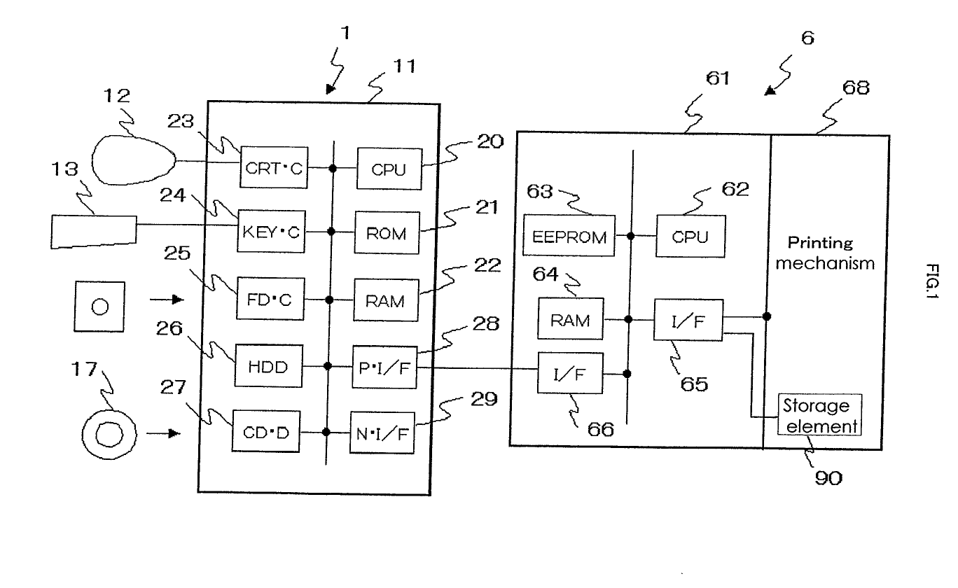

A printing system of the present embodiment is provided with, as shown in FIG. 1, a host computer (hereinafter, referred to as “host”) 1 and a printer 6 which is a printing apparatus that prints out print data output from the host 1.

The host 1 is provided with a host main unit 11, a display 12 and a keyboard 13. The host main unit 11 has: a CPU 20 executing various programs; a ROM 21 storing various data and programs; a RAM 22 temporarily storing various data and programs; a display controller 23 controlling the display 12; a keyboard controller 24 controlling the keyboard 13; a floppy disk drive 25; a hard disk drive 26; a CD-ROM drive 27; a printer interface 28; and a net interface 29.

The printer 6 is, for example, an ink jet printer capable of color printing, and when receiving print data from the host 1, executes a predetermined printing process to form an image on a print sheet which is a print medium. The printer 6 has a printing mechanism 68 actually carrying out printing, and a printing control portion 61 controlling these. The printing control portion 61 has: a CPU 62 executing various programs; an EEPROM 63 storing various data and programs; a RAM 64 temporarily storing various data and programs; interfaces 65 and 66 exchanging data with the host 1 or the printing mechanism 68; and the printing mechanism 68. The printing mechanism 68 has a storage element 90 (the recording medium of the present invention). Preferably, the storage element 90 is attached to a case containing a printing coloring agent such as ink or toner and being detachably attachable to the printing mechanism 68. More preferably, the storage element 90 comprises a semiconductor memory such as an IC (integrated circuit).

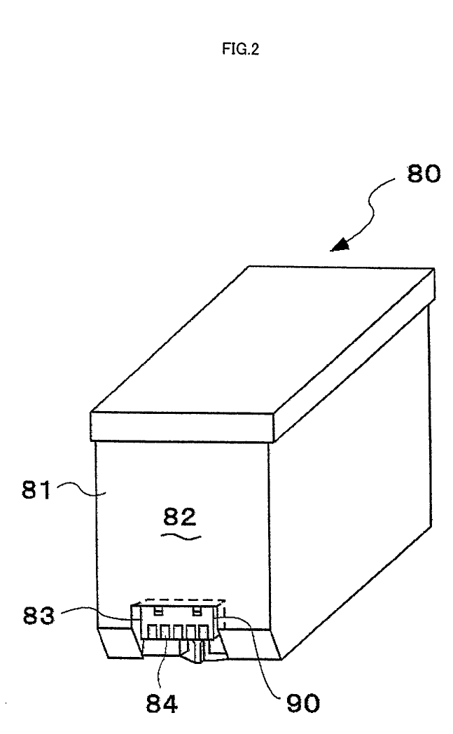

Next, an example of the case containing the printing coloring agent and to which the storage element 90 is attached will be described with reference to FIG. 2. FIG. 2 shows the appearance of an ink cartridge 80 to which the storage element 90 is attached. The ink cartridge 80 is provided with a cartridge main body 81 constituting an ink container containing ink inside, and the storage element 90 incorporated in a side frame portion 82 of the cartridge main body 81. In the storage element 90, ink cartridge identification information and information on the ink amount are stored.

The storage element 90 exchanges various data with the printing control portion 61 by being connected to the interface 65 of the printing control portion 61 when the ink cartridge 80 is attached to a non-illustrated cartridge attached portion of the printing mechanism 68 of the printer 6. “Connection” mentioned here may be either with contact or without contact. Therefore, although a contact-type storage element is used in the description given below, a non-contact-type storage element may be used. Since the storage element 90 is attached to a concave portion 83, being opened at the bottom, of the side frame portion 82 of the ink cartridge 80, only a plurality of connection terminals 84 is exposed. While an ink cartridge is described here, the cartridge may be a toner cartridge having inside a toner container for containing toner inside.

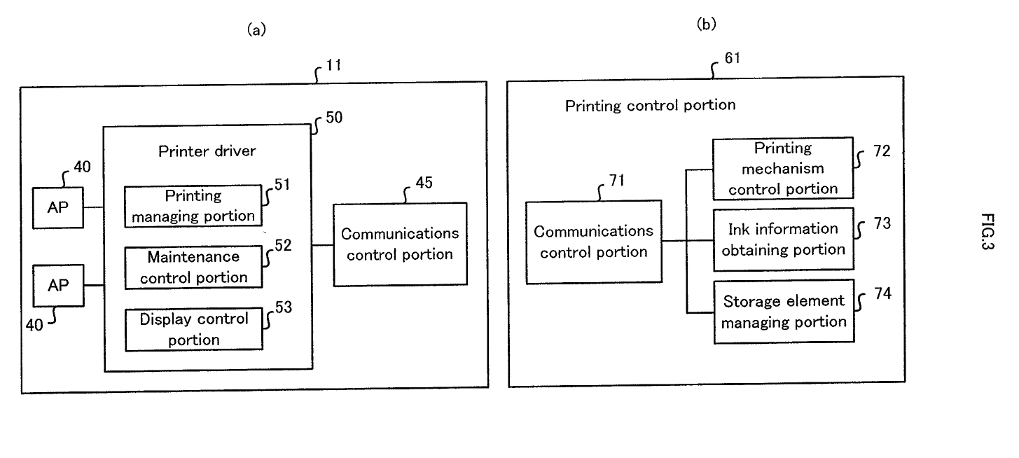

Next, the -internal functions of the host 1 and the printer 6 will be described. FIG. 3 is a functional structure view of the host land the printer 6. The host main unit 11 is provided with applications 40, a communications control portion 45 and a printer driver 50. These functions are each realized by the CPU 20 executing a predetermined program.

The communications control portion 45 controls communications with the printer 6. For example, the communications control portion 45 outputs printing requests including print data and maintenance instructions to the printer 6.

The printer driver 50 has as functions thereof a printing managing portion 51, a maintenance control portion 52 and a display control portion 53.

The printing managing portion 51 receives printing instructions from the applications 40 or the keyboard 13, and generates print data based thereon. The generated print data is passed to the communications control portion 45.

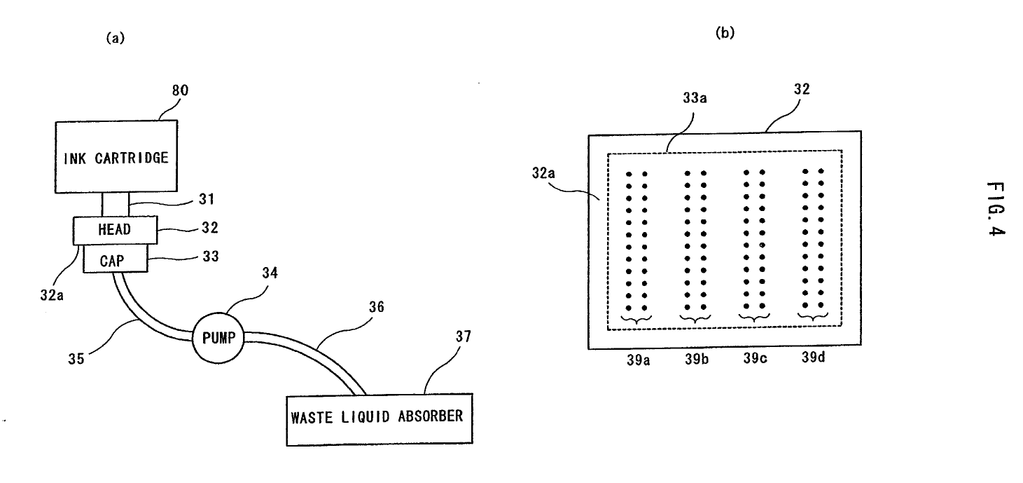

The maintenance control portion 52 controls the printer 6 when the printer 6 carries out various kinds of maintenance. For example, the maintenance control portion 52 controls cleaning of the print head. FIG. 4(a) schematically shows the cleaning mechanism of the print head of the printer 6.

Ink is supplied from the ink cartridge 80 attached to the printing mechanism 68 through a pipe 31 to a print head 32. A nozzle surface 32a of the print head 32 is shown in FIG. 4(b). On the nozzle surface 32a, nozzles 39a, 39b, 39c and 39d for spraying inks of C (cyan), M (magenta), Y (yellow) and K (black), respectively, are arranged. When normal printing is carried out, ink is sprayed from the nozzles 39a, 39b, 39c and 39d. When head cleaning is carried out, the opened part of a box-shaped cap 33 is attached to the nozzle surface 32a. The part 33a where the opened part of the cap 33 abuts on the nozzle surface 32a when the print head 32 is attached is as shown in FIG. 4(b). At this time, the nozzles 39a, 39b, 39c and 39d of all of the colors C, M, Y and K are covered with the cap 33. The space in the cap 33 communicates with a pump 34 through a pipe 35. The pump 34 is connected to a waste liquid absorber 37 through a pipe 36.

When head cleaning is carried out, the pump 34 forcibly sucks ink from the nozzle 39. At this time, inks of all of the colors C, M, Y and K are absorbed. The sucked ink is dropped into the cap 33 and absorbed by the waste liquid absorber 37 through the pipes 35 and 36. Consequently, clogging of the head is resolved, so that so-called character omission never occurs.

This head cleaning includes the following cases: a case where cleaning is carried out in response to an instruction from the user issued on a utility selection screen 100 described next (hereinafter, referred to as maintenance 1); a case where cleaning is carried out, when printing is not carried out for a predetermined period of time (for example, two weeks) or longer, in the initial processing carried out when the power is turned on (hereinafter, referred to as maintenance 2); and a case where cleaning is carried out when the ink cartridge is replaced (hereinafter, referred to as maintenance 3).

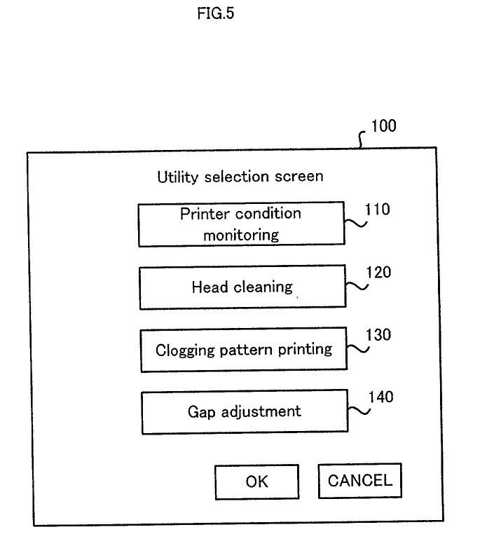

The display control portion 53 displays user interface screens and the like on the display 12. For example, the display control portion 53 displays the utility selection screen 100 shown in FIG. 5. By using the screen 100, head cleaning can be carried out at a given point of time desired by the user.

The utility selection screen 100 is a screen accepting the user's selection of a utility function. The utility selection screen 100 has buttons 110, 120, 130 and 140 accepting selections of printer condition monitoring, head cleaning, clogging pattern printing and gap adjustment, respectively. When the head cleaning button 120 is depressed, the above-described cleaning of the print head of the printer is carried out.

The printing control portion 61 has as internal functions thereof a communications control portion 71, a printing mechanism control portion 72, an ink information obtaining portion 73 and a storage element managing portion 74. These functions are each realized by the CPU 62 executing a predetermined program.

The communications control portion 71 controls communications with the host 1. For example, the communications control portion 71 accepts print data and maintenance instructions from the host 1.

The printing mechanism control portion 72 accepts printing requests from the host 1 and passes the print data to the printing control portion 61 to carry out printing.

The ink information obtaining portion 73 obtains information representative of the amount of ink used for normal printing or the amount of ink consumed when maintenance is carried out. For example, the ink information obtaining portion 73 measures the amount of ink consumed when printing is carried out. Specifically, the ink information obtaining portion 73 counts the number of dots of sprayed ink to thereby estimate the ink amount. The ink information obtaining portion 73 also counts the number of times of dummy ink spraying called flushing, and estimates the amount of the consumed ink. Flushing is to spray ink to an absorber disposed outside a printing range at regular time intervals to prevent ink in the vicinity of the exit of the nozzle from being dried when the cap is opened (hereinafter, referred to as maintenance 4).

The amount of ink consumed when each of the maintenance 1, the maintenance 2 and the maintenance 3 is carried out once is almost the same among the same models of printers 6. Each printer 6 stores the numerical values in a non-illustrated storage portion. The ink information obtaining portion 73 estimates the consumption amount of ink every time each of the maintenance 1, the maintenance 2 and the maintenance 3 is carried out.

In addition to the above-described method indirectly estimating the consumption amount of ink, information representative of the ink amount may be obtained by attaching a sensor and directly measuring the consumption amount of ink or the residual amount of ink.

The storage element managing portion 74 carries out reading or writing of information stored in a storage area of the storage element 90 when the ink cartridge 80 is attached to the printing mechanism 68 of the printer 6. For example, the storage element managing portion 74 writes predetermined information into the storage element 90 based on the information representative of the ink amount obtained by the ink information obtaining portion 73. The predetermined information is information for the total consumption amount of ink of the ink cartridge 80 to be shown. Specifically, for example, it may be carried out to calculate the total consumption amount based on the information representative of the ink amount and update the storage contents of ink amount information 900 (update type). Alternatively, it may be carried out to add the information representative of the ink amount to the ink amount information 900 so that the total consumption amount is found when the information is read out (addition type).

When a request to read out the ink amount information 900 is accepted, the ink amount information 900 stored in the storage element 90 is read out.

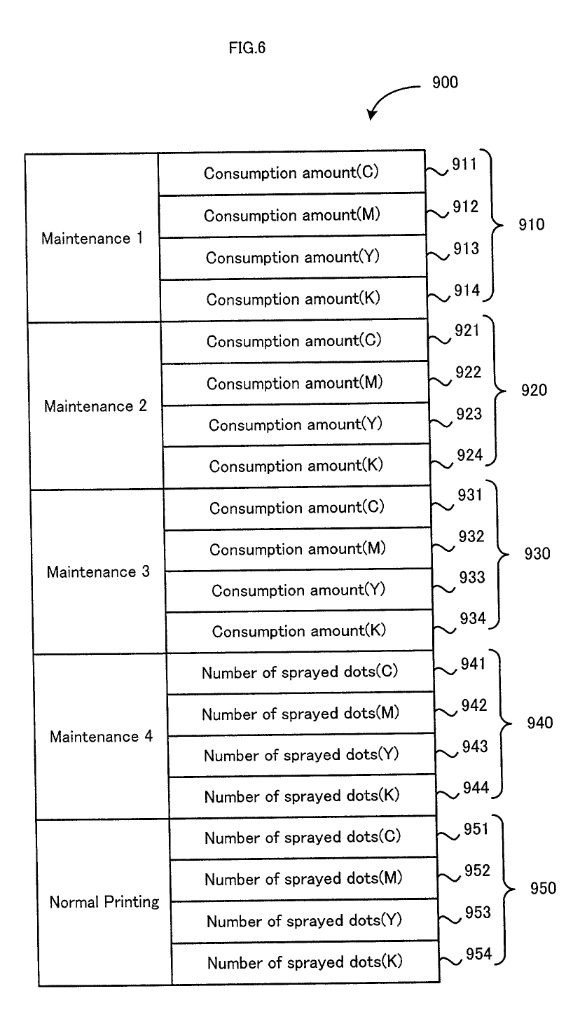

Data items of the ink amount information 900 are shown in FIG. 6. The ink amount information 900 has as data items thereof an amount 910 of the ink consumed when the maintenance 1 is carried out, an amount 920 of the ink consumed when the maintenance 2 is carried out, an amount 930 of the ink consumed when the maintenance 3 is carried out, the number 940 of the dots sprayed when the maintenance 4 is carried out, and the number 950 of the dots sprayed when normal printing is carried out. Areas for storing the consumption amounts 910, 920 and 930 and the dot numbers 940 and 950 are provided for each of C, M, Y and K. The items may be either the update type or the addition type.

While the consumption amount of ink is stored for the maintenance 1, the maintenance 2 and the maintenance 3 in the present invention, the number of times the maintenance is carried out may be stored. In that case, when the number of times of execution is read out from the ink amount information 900, a processing to convert it to the consumption amount is carried out as required. Moreover, while the number of sprayed dots is stored in the cases of the maintenance 4 and normal printing, it may be carried out to convert the number of dots to the consumption amount of ink and store the consumption amount of ink.

By the present embodiment, the amount of ink consumed for printing and the amount of ink consumed for maintenance can be stored in the storage element 90 provided in the ink cartridge 80.

Now, the correspondence between the elements of the present embodiment and the present invention will be clarified. The printer 6 of the present embodiment corresponds to the coloring agent amount recording apparatus of the present invention. The ink information obtaining portion 73 corresponds to the information obtaining portion. The storage element managing portion 74 corresponds to the information writing portion. Of the information written in the storage element 90, the amount of ink consumed for maintenance directly corresponds to the “information on the amount not used in actual printing.” The amount of ink consumed for printing indirectly corresponds to the “information on the amount not used in actual printing” because the residual amount of ink (the amount of ink not used in actual printing) is obtained by subtracting the amount of ink consumed in actual printing and the amount of ink consumed for maintenance from a known initial ink amount.

According to the present embodiment described above in detail, by reading out the contents of the storage element 90 later, the amount of ink not used in actual printing can be grasped. Moreover, since the storage element 90 is attached to the ink cartridge 80, it can be clarified to which ink cartridge 80 the contents read out from the storage element 90 correspond. Further, the residual amount of ink and the amount of ink used for maintenance which are causes of user dissatisfaction can be grasped, arrangements to resolve user dissatisfaction can betaken. Furthermore, the residual amount of ink and the amount of ink used for maintenance can be grasped for each color.

[Second Embodiment]

Next, a second embodiment to which the present invention is applied will be described.

In some color ink cartridges, when the ink of at least one of a plurality of colors runs out, printing cannot be carried out even if the inks of the other colors remain. This dissatisfies users. Moreover, ink is consumed when maintenance of the print head is carried out. Bearing of the costs of ink consumed for maintenance also dissatisfies users.

The present embodiment provides a sales managing apparatus 200 for resolving such user dissatisfaction. The present embodiment uses the ink cartridge 80 provided with the storage element 90 in which the ink amount information 900 is written in the first embodiment.

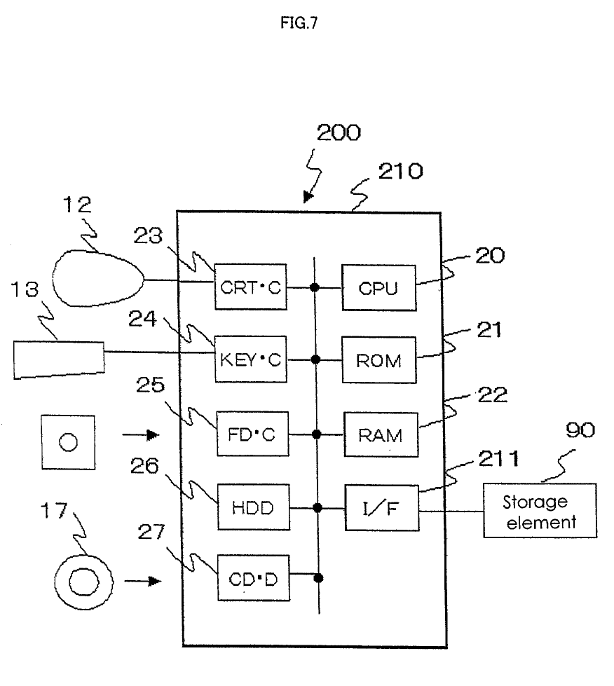

The present embodiment is provided with a sales managing apparatus 200 as shown in FIG. 7. The sales managing apparatus 200 is provided with an information processor main unit 210, a display 12 and a keyboard 13. The information processor main unit 210 has a CPU 20, a ROM 21, a RAM 22, a display controller 23, a keyboard controller 24, a floppy disk drive 25, a hard disk drive 26, a CD-ROM drive 27, and an interface 211 for connection with the storage element 90.

Further, the sales managing apparatus 200 is provided with an on-illustrated mechanism for attaching the ink cartridge 80. When the ink cartridge 80 is attached to the attachment mechanism, the storage element 90 is connected to the interface 211.

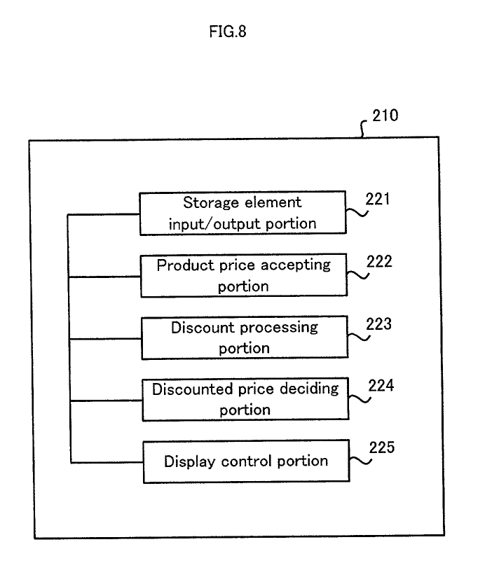

The functional structure view of the sales managing apparatus 200 is shown in FIG. 8. The sales managing apparatus 200 has as internal functions thereof a storage element input/output portion 221, a product price accepting portion 222, a discount processing portion 223, a discounted price deciding portion 224 and a display control portion 225. These functions are each realized by the CPU 20 executing a predetermined program.

The storage element input/output portion 221 reads out the ink amount information 900 stored in the storage element 90. Moreover, when a discount processing by the discount processing portion 223 is carried out, the storage element input/output portion 221 writes into the storage element 90 information representing that the discount processing has been completed.

The product price accepting portion 222 accepts the price of the product to be sold or the service to be provided. For example, the product price accepting portion 222 accepts the price of a product or the like entered with the keyboard 13.

The discount processing portion 223 carries out a discount processing for a product or a service. For example, the discount processing portion 223 carries out a discount processing based on the ink amount information 900 read out by the storage element input/output portion 221. Specifically, when the ink of one color runs out in a color ink cartridge, based on the ink amount information 900, the discount processing portion 223 estimates the residual amounts of the inks of the other colors or the amount of the unused ink that cannot be used for printing. The amount of the unused ink may be estimated, for example, by counting backward from the number of times of ink spraying in normal printing. The residual amounts of ink may be estimated by counting backward from the sum total of the amount of ink used for normal printing and the amount of ink used for maintenance. Further, the discount amount may be decided by combining the residual amounts of ink and the amount consumed for maintenance. Cash corresponding to the discount amount may be returned, or points corresponding to the discount amount may be issued so that the user can use them when the user makes next and succeeding purchases.

The discounted price deciding portion 224 decides the discounted price based on the price of the product to be sold or the service to be provided and which price is accepted by the product price accepting portion 222, and the discount amount decided by the discount processing portion 223. For example, the discounted price is obtained by subtracting the discount amount from the price of the product or the like.

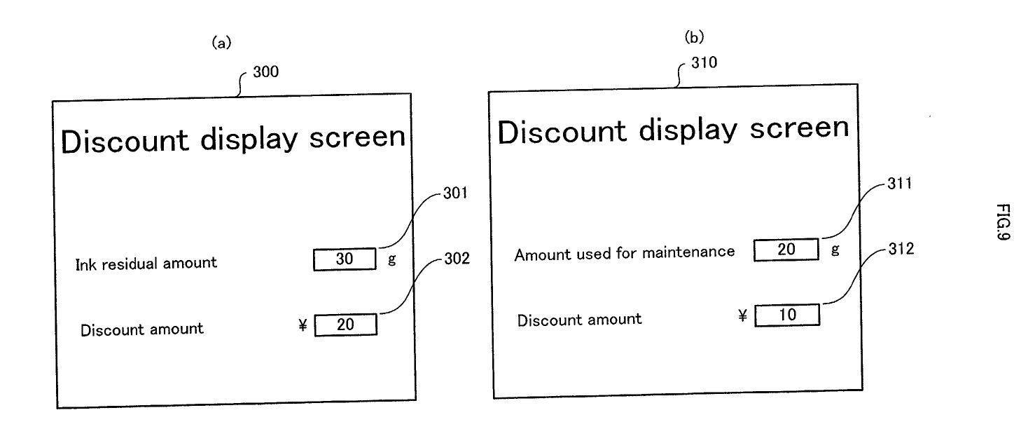

The display control portion 225 displays the result of the processing by the discount processing portion 223 or the discounted price deciding portion 224 on the display 12. For example, the display control portion 225 displays discount display screens 300 and 310 shown in FIG. 9(a) and FIG. 9(b) on the display 12. The discount display screen 300 shown in FIG. 9(a) is provided with an area 301 for displaying the residual amount of ink and an area 302 for displaying the discount amount corresponding thereto. The discount display screen 310 shown in FIG. 9(b) is provided with an area 311 for displaying the amount used for maintenance, and an area 312 for displaying the discount amount corresponding thereto.

Now, the correspondence between the elements of the present embodiment and the present invention will be described. The sales managing apparatus 200 of the present embodiment corresponds to the coloring agent materials cost processing apparatus of the present invention. The storage element input/output portion 221 corresponds to the information reading portion. The discount processing portion 223 corresponds to the materials cost generating portion.

According to the present embodiment described above in detail, based on the information on the amount of ink not used in actual printing, the discount amount (materials cost) of the amount of ink is generated, and the user is required to pay a discounted price obtained by subtracting the discount amount from the price of the product or the like purchased by the user. That is, a refund is made to the user as the discount amount. Consequently, user dissatisfaction with the residual amount of ink and the amount of ink used for maintenance can be resolved. Since the information representing that the discount processing has been completed is written into the storage element 90 after the discount processing by the discount processing portion 223 is carried out, there is no possibility that the information on the amount of ink not used in actual printing is read out from the storage element 90 more than once, so that there is no possibility that the materials cost is paid more than once.

The sales managing apparatus 200 described in the second embodiment can also be realized by a combination of the host 1 and the printer 6 described in the first embodiment. Moreover, in the present embodiment, the product price accepting portion 222 and the discount price deciding portion 224 can be omitted. When these are omitted, the sales managing apparatus 200 is provided with only a function to decide the discount amount. In addition thereto, for the elements described in the first and the second embodiments, changes in combination, addition and omission can be made as much as possible.

Moreover, even when each color ink has a different unit price, since the residual amount of ink and the amount of ink used for maintenance are recorded for each color as shown in FIG. 6, it can be carried out to obtain the materials cost for each color and refund the sum total thereof to the user.

[Third Embodiment]

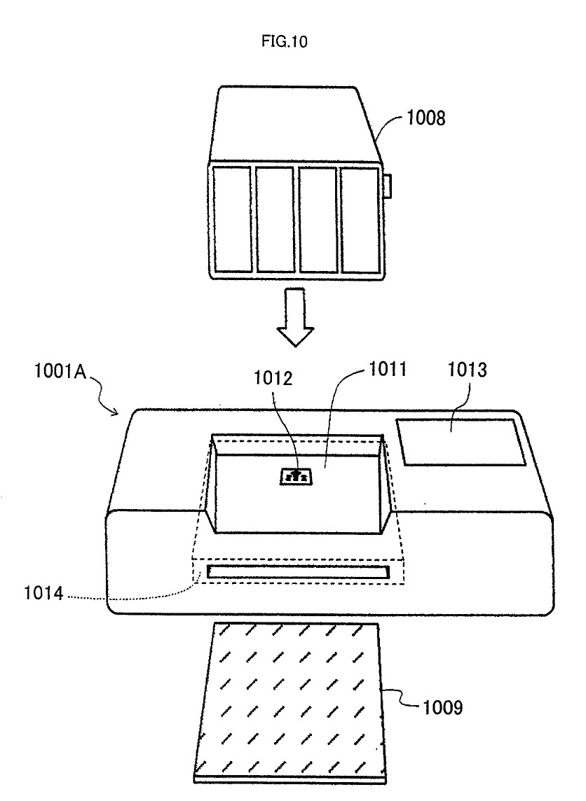

A residual ink materials cost refunding apparatus according to the present embodiment will be described with reference to FIG. 10 through FIG. 14. The present embodiment is an example of the coloring agent materials cost processing apparatus, comprising the materials cost recording portion, of the present invention. FIG. 10 is an external view of the residual ink materials cost refunding apparatus. In the residual ink materials cost refunding apparatus 1001A, a cartridge attachment portion 1011 having a groove shape opened at the front and the top is formed. Moreover, a terminal area 1012 is formed on the rear side of the bottom surface thereof. Further, in an upper part of the residual ink materials cost refunding apparatus 1001A, a display 1013 is provided, and in a front part, a card information reader/writer 1014 for attaching a point card 1009 is provided.

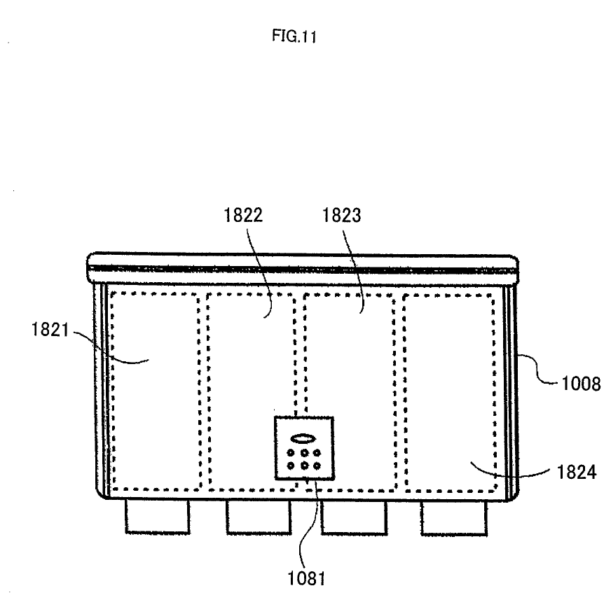

An ink cartridge 1008 attached to the cartridge attachment portion 1011 is a four-color cartridge as shown in FIG. 11 in the present embodiment. The ink cartridge 1008 has four ink tanks 1821 through 1824, and is provided with an IC memory 1081. The cartridge attachment portion 1011 is structured so that the terminal area 1012 formed on the bottom surface is in contact with a terminal of the IC memory 1081 when the ink cartridge 1008 is attached.

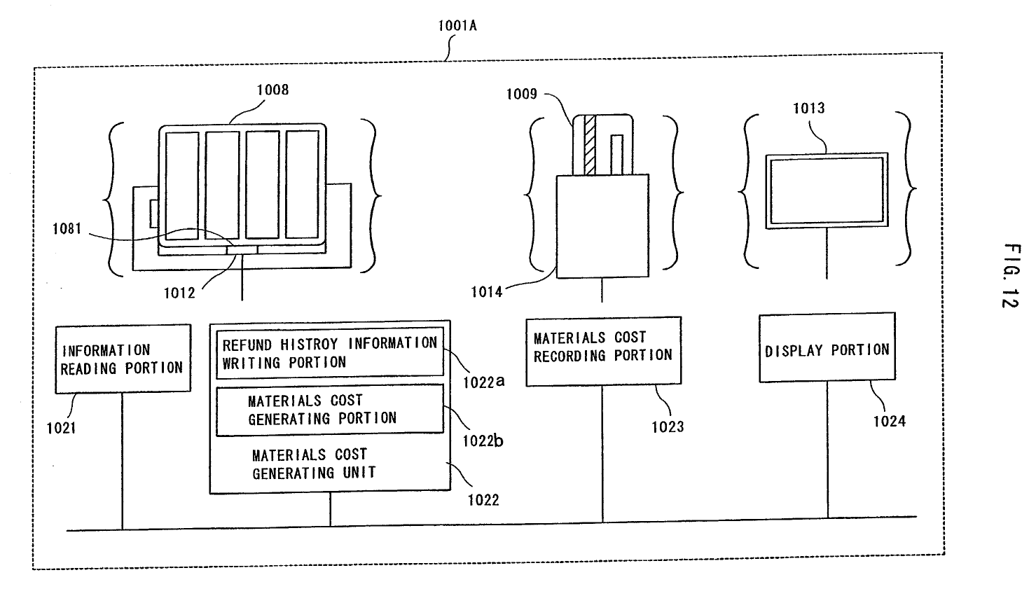

FIG. 12 is a view showing the internal structure of the residual ink materials cost refunding apparatus 1001A. In FIG. 12, the residual ink materials cost refunding apparatus 1001A comprises an information reading unit 1021, a materials cost generating unit 1022, a materials cost recording unit 1023 and a display unit 1024. In FIG. 12, for ease of understanding of the present embodiment, for the units 1021 through 1024, the correspondence with the elements shown in FIG. 10 is shown in the parentheses.

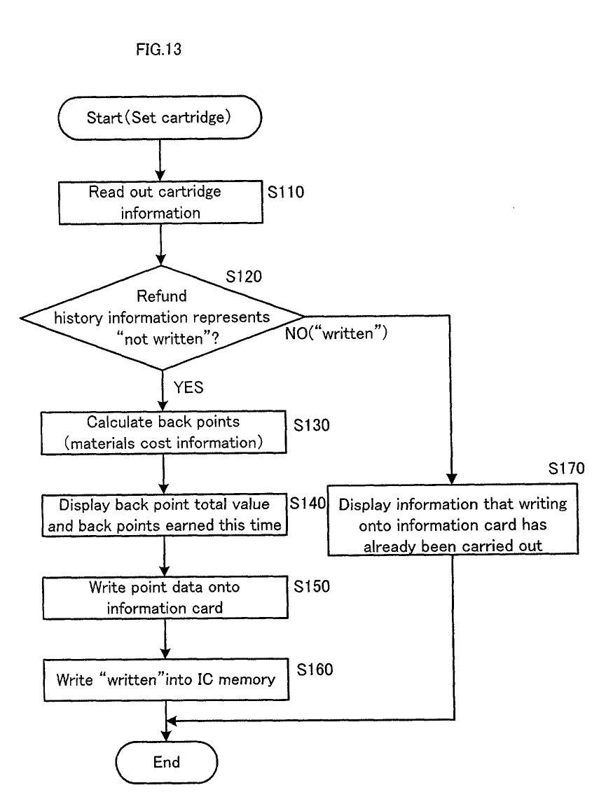

Now, the action of the present embodiment will be described with reference also to the flowchart of FIG. 13. In FIG. 10, when the ink cartridge 1008 is set in the cartridge attachment portion 1011, a message prompting the user to set the point card 1009 into the card information reader/writer 1014 is displayed on the display 1013 (the display 1013 substantially constitutes the display unit 1024 of FIG. 12).

When the point card 1009 is set in the card information reader/writer 1014, the cartridge information stored in the IC memory 1081 is read out by a cartridge information obtaining program (step S110 of FIG. 13). The terminal 1012 and the cartridge information obtaining program substantially constitute the information reading unit 1021 of FIG. 12.

The cartridge information includes not only ink residual amount data but also refund history information representing whether materials cost information has been written or not, that is, representing either “written” or “not written.” As described later, when writing from the IC memory 1081 to the point card 1009 was not carried out in the past, the refund history information represents “not written,” and when writing from the IC memory 1081 to the point card 1009 was carried out in the past, the refund history information represents “written.” Whether the refund history information represents “not written” or “written” is determined by a refund history information writing program provided in the residual ink materials cost refunding apparatus 1001A (step S120 of FIG. 13). The terminal 1012 and the refund history information writing program substantially constitute a refund history information writing portion 1022a of the materials cost generating unit 1022 of FIG. 12.

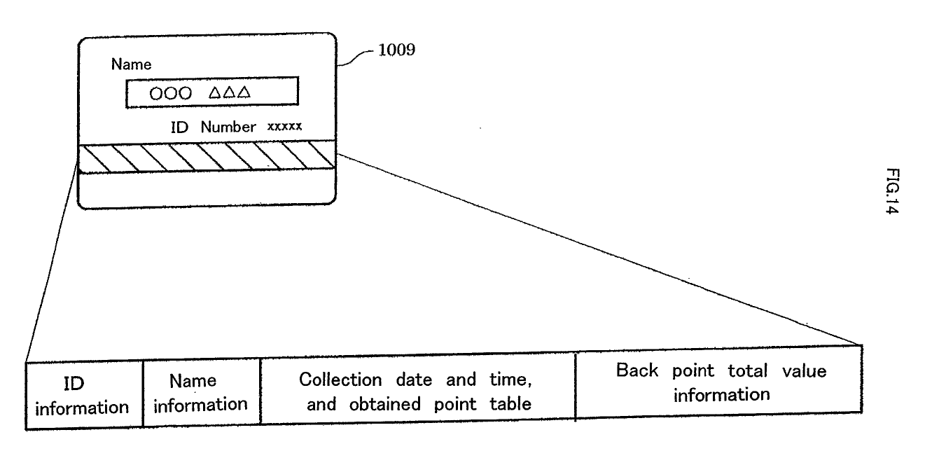

When the refund history information represents “not written,” the ink residual amount data is read out from the IC memory 1081 of the ink cartridge 1008, and the back points (materials cost information, hereinafter referred to as “back points earned this time”) for the ink cartridge 1008 are calculated (step S130 of FIG. 13). This calculation substantially constitutes a materials cost generating portion 1022b of the materials cost generating unit 1022 of FIG. 12. The card information reader/writer 1014 reads out the current materials cost (“back point total value” recorded on the point card 1009), and the back point total value and the back points earned this time are displayed on the display 1013 (step S140 of FIG. 13). In the storage area of the point card 1009, as shown in FIG. 14, “ID information,” “name information,” “collection date and time and obtained point table,” and “back point total value information” are written.

Then, the card information reader/writer 1014 adds the back points earned this time to the back point total value, and writes the result onto the point card 1009 (step S150 of FIG. 13). At the same time, the card information reader/writer 1014 writes “written” into the IC memory 1081 as the refund history information (step S160 of FIG. 13).

When the refund history information represents “written” (see step S120 of FIG. 13), the writing of the materials cost information onto the point card 1009 by the card information reader/writer 1014 (the materials cost recording unit 1023 in FIG. 12) is not carried out, and information that “the materials cost information has already been written on the point card” is displayed on the display 1013 (step S170 of FIG. 13).

According to the present embodiment described above in detail, the back points (materials cost) corresponding to the residual amount of ink is generated based on the ink residual amount data representative of the amount of ink not used in actual printing, the generated back points are added to the current back points, and the result is written, as the back point total value, onto the point card 1009 which is the target of recording. That is, a refund is made to the user as back points. The back points are exchangeable for cash or goods according to the number of points. Consequently, user dissatisfaction with the amount of residual ink that cannot be completely used can be resolved. Moreover, since “written” is written into the IC memory 1081 after the point data is written, there is no possibility that the ink residual amount data is read out from the IC memory 1081 more than once, so that there is no possibility that the materials cost is paid more than once. Further, it is possible to make a refund to the user by reading out the point data recorded on the point card 1009 at an appropriate time and exchanging the back points for cash or the like or to confirm the number of points. Furthermore, it is possible for the user to carry the point card 1009, save back points and exchange back points for goods that the user wants.

While the residual amount of ink is treated as the amount of ink not used in actual printing in the present embodiment, the amount of ink used for maintenance may be treated as the amount of ink not used in actual printing as well as the residual amount of ink like in the first and the second embodiments so that the amount is also converted to points for which a refund is made to the user.

[Fourth Embodiment]

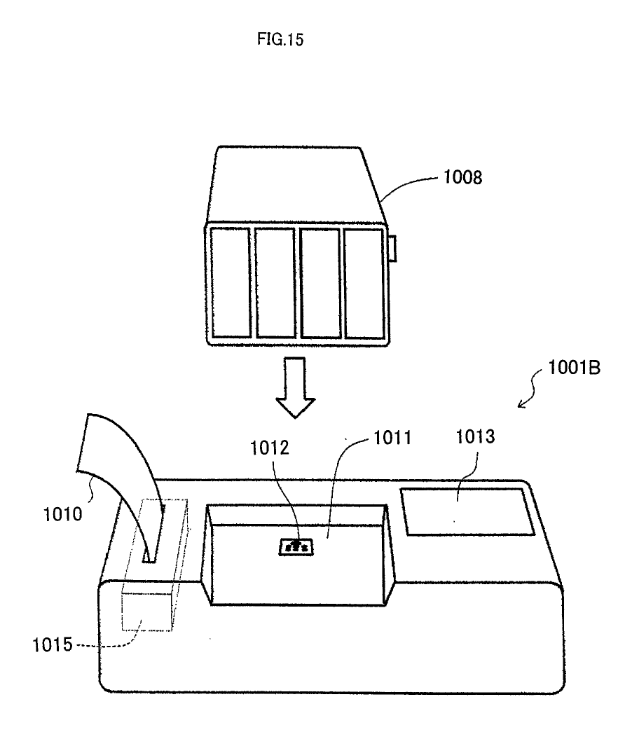

A residual ink materials cost refunding apparatus according to the present embodiment will be described with reference to FIGS. 15 through 17. The present embodiment is an example of the coloring agent materials cost processing apparatus of the present invention. FIG. 15 is an external view of the residual ink materials cost refunding apparatus. In the residual ink materials cost refunding apparatus 1001B, like in the residual ink materials cost refunding apparatus 1001A of the third embodiment, a cartridge attachment portion 1011 having a groove shape opened at the front and the top is formed, a terminal area 1012 is formed on the rear side of the bottom surface thereof, and in an upper part of the residual ink materials cost refunding apparatus 1001B, a display 1013 is provided. In the residual ink materials cost refunding apparatus 1001B of the present embodiment, unlike in the residual ink materials cost refunding apparatus 1001A, the card information reader/writer is not provided, and a printer 1015 issuing vouchers is newly provided.

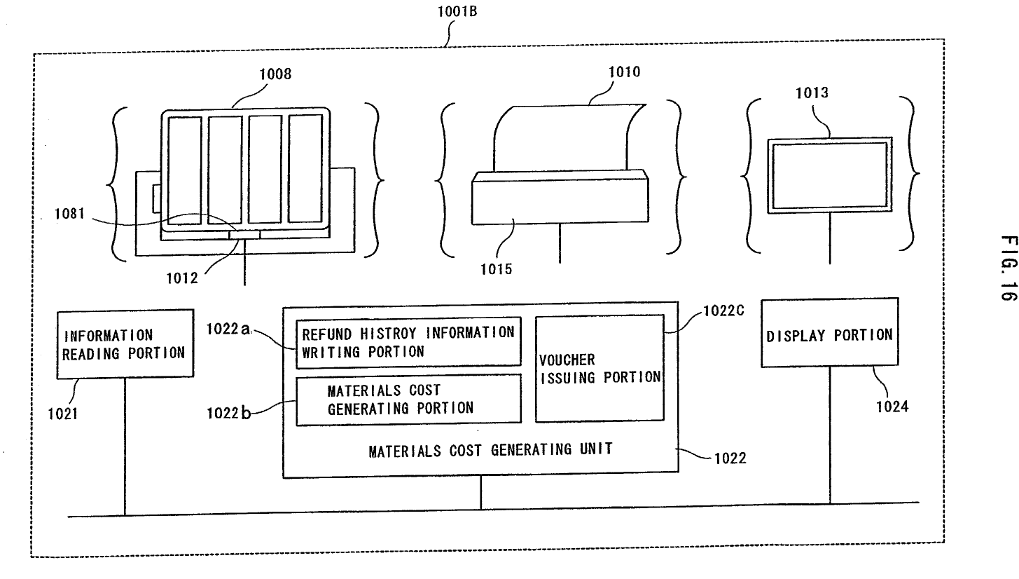

FIG. 16 is a view showing the internal structure of the residual ink materials cost refunding apparatus 1001B. In FIG. 16, the residual ink materials cost refunding apparatus 1001B has an information reading unit 1021, a materials cost generating unit 1022 and a display unit 1024 like in the residual ink materials cost refunding apparatus 1001A of the third embodiment. In FIG. 16, in the residual ink materials cost refunding apparatus 1001B, unlike in the residual ink materials cost refunding apparatus 1001A, the materials cost recording unit 1023 is not provided, and a voucher issuing portion 1022c is provided in the materials cost generating unit 1022. In FIG. 16, for ease of understanding of the present embodiment, for the units 1021 through 1023 and 1025, correspondence with the elements shown in FIG. 15 is shown in the parentheses.

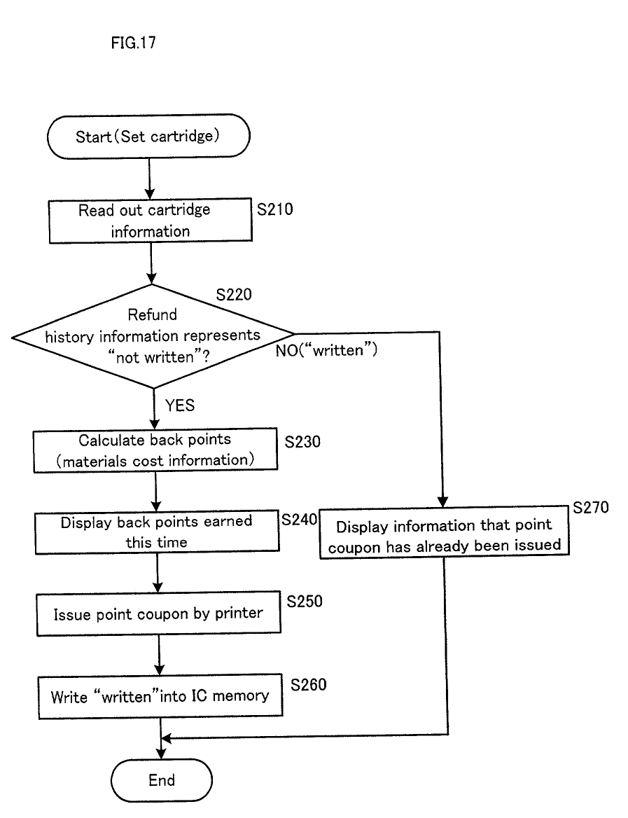

Now, the action of the present embodiment will be described with reference to the flowchart of FIG. 17.

In the present embodiment, in a similar manner to that of the third embodiment, the cartridge data is read out at step S210 of FIG. 17, and at step S220, it is determined whether the refund history information represents “not written” or not. At step S230 of FIG. 17, when the refund history information included in the cartridge information in the IC memory 1081 of the ink cartridge 1008 represents “not written,” the ink residual amount data is read out from the IC memory 1081, and the back points earned this time for the ink cartridge 1008 are calculated.

In the present embodiment, only the back points earned this time are displayed on the display 1013 (step S240 of FIG. 17). Then, a voucher (a point coupon 1010 in FIG. 15) is issued by the printer 1015 (step S250 of FIG. 17), and at the same time, “written” is written into the IC memory 1081 as the refund history information (step S260 of FIG. 17).

When the refund history information represents “written” (see step S220 of FIG. 17), the issue of the point coupon 1010 by the printer 1015 (by the voucher issuing portion 1022c in FIG. 12) is not carried out, and information that “the point coupon has already been issued” is displayed on the display 1013 (step S270 of FIG. 17).

According to the present embodiment described above in detail, back points (materials cost) corresponding to the residual amount of ink are generated based on the ink residual amount data representative of the amount of ink not used in actual printing, and the point coupon 1010 corresponding to the back points is issued. That is, a refund is made to the user as the point coupon 1010. The point coupon 1010 is exchangeable for cash or goods according to the number of points. Consequently, user dissatisfaction with the amount of residual ink that cannot be completely used can be resolved. Moreover, since “written” is written into the IC memory 1081 after the point data is written, there is no possibility that the ink residual amount data is read out from the IC memory 1081 more than once, so that there is no possibility that the materials cost is paid more than once.

While the residual amount of ink is treated as the amount of ink not used in actual printing in the present embodiment, the amount of ink used for maintenance may be treated as the amount of ink not used in actual printing as well as the residual amount of ink like in the first and the second embodiments so that the amount is also converted to points for which a refund is made to the user.

[Fifth Embodiment]

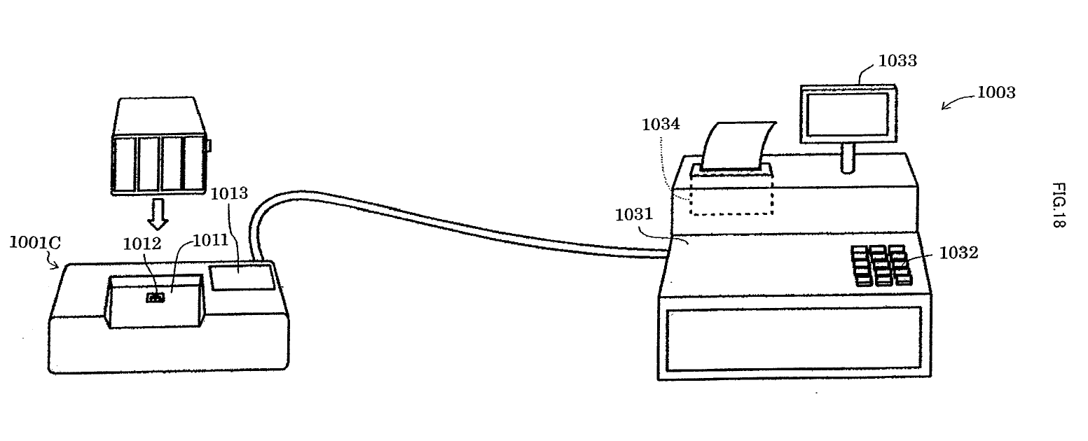

A residual ink materials cost refunding system according to the present embodiment will be described with reference to FIG. 18 through FIG. 21. The present embodiment is an example of the coloring agent materials cost processing apparatus of the present invention. FIG. 18 is a schematic view of the residual ink materials cost refunding system. The system comprises a residual ink materials cost refunding apparatus 1001C. and a cash register 1003. In the residual ink materials cost refunding apparatus 1001C, a cartridge attachment portion 1011 having a groove shape similar to those of the residual ink materials cost refunding apparatuses 1001A and 1001B of FIG. 10 and FIG. 15 is formed. In the residual ink materials cost refunding apparatus 1001C of the present embodiment, like in the residual ink materials cost refunding apparatuses 1001A and 1001B of FIG. 10 and FIG. 15, a terminal area 1012 is formed on the rear side of the bottom surface, and in an upper part of the residual ink materials cost refunding apparatus 1001C, a display 1013 is provided. Although not shown in FIG. 18, a communications circuit for performing communications with the cash register 1003 is incorporated in the residual ink materials cost refunding apparatus 1001C. In the residual ink materials cost refunding apparatus 1001C, neither the card information reader/writer shown in FIG. 10 nor the printer 1015 shown in FIG. 15 is provided.

In FIG. 18, the cash register 1003 has a similar appearance to normal cash registers, and a main body 1031 is provided with a keyboard 1032, a display 1033 and a receipt printer 1034. Although not shown in FIG. 18, a communications circuit for performing communications with the residual ink materials cost refunding apparatus 1001C is incorporated in the cash register 1003.

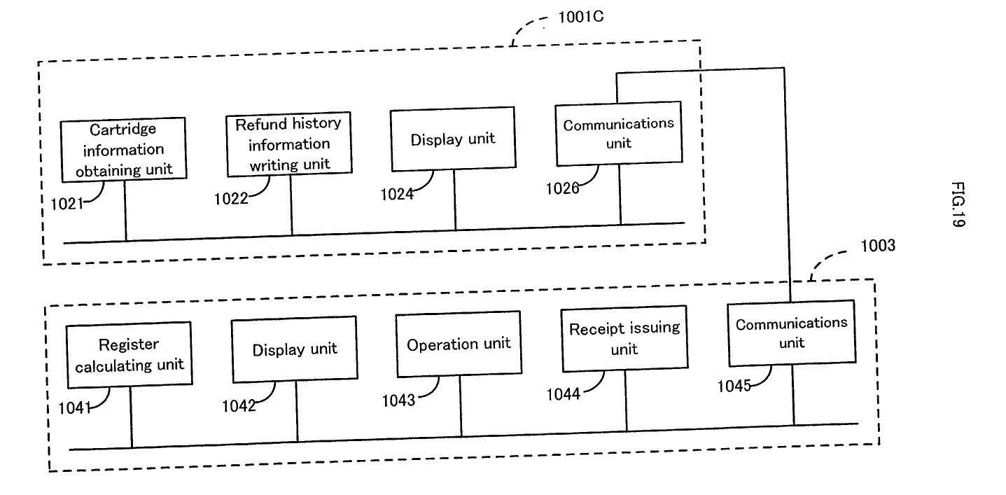

FIG. 19 is a system diagram showing the internal structure of the residual ink materials cost refunding apparatus 1001° C. and the internal structure of the cash register 1003 as functional blocks. In FIG. 19, the residual ink materials cost refunding apparatus 1001C has a communications portion 1026 as well as an information reading unit 1021, a materials cost generating unit 1022 including a refund history information writing portion 1022a, and a display unit 1024 similar to those shown in FIG. 10 and FIG. 15. Moreover, in FIG. 19, the cash register 1003 has a register calculating unit 1041, a display unit 1042, an operation unit 1043, a receipt issuing unit 1044, and a communications unit 1045. Moreover, the communications portion 1026 of the residual ink materials cost refunding apparatus 1001C is line-connected to the communications unit 1045 of the cash register 1003.

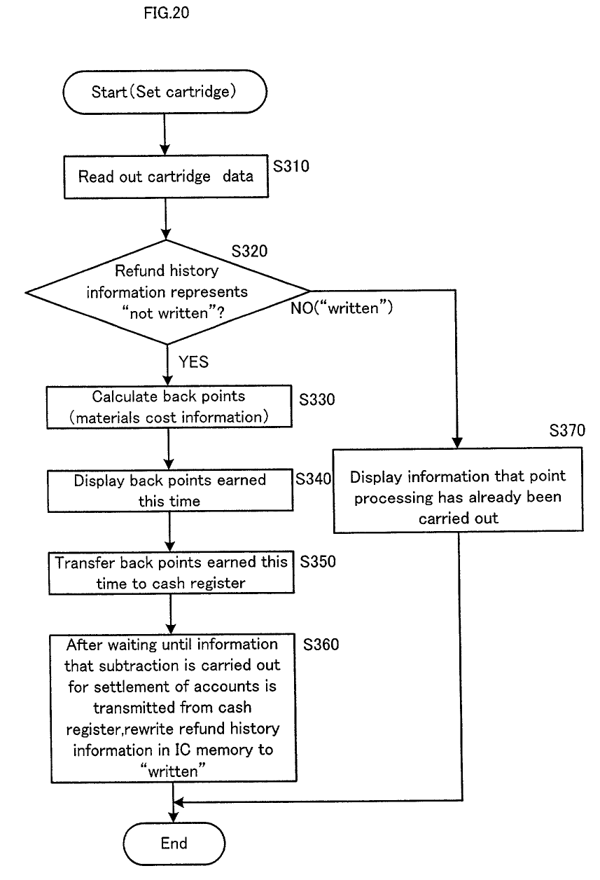

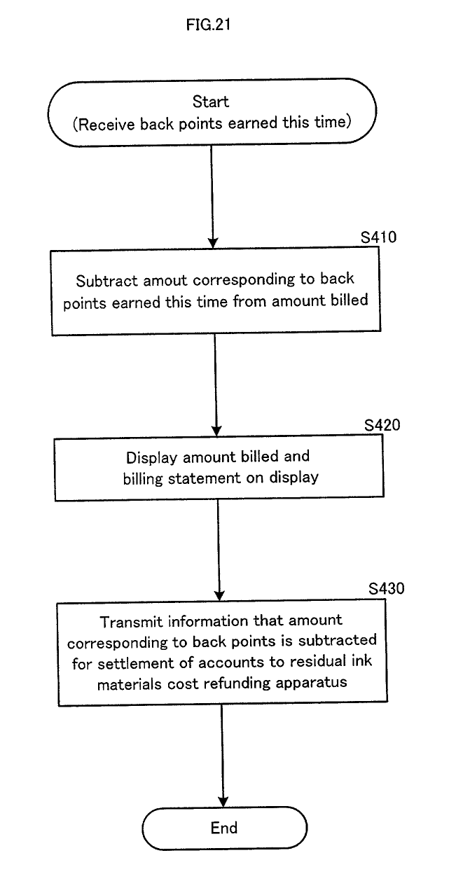

Now, the action of the present embodiment will be described with reference to the flowcharts of FIG. 20 and FIG. 21.

In the present embodiment, like in the flowcharts of FIG. 13 and FIG. 17, the cartridge data is read out at step S310, and it is determined whether the refund history information represents “not written” or not at step S320. At step S330 of FIG. 19, like at step S230 of the flowchart of FIG. 17, when the refund history information included in the cartridge information in the IC memory 1081 of the ink cartridge 1008 represents “not written,” the ink residual amount data is read out from the IC memory 1081, the back points earned this time for the ink cartridge 1008 are calculated, and the back points earned this time are displayed on the display 1013 (step S340 of FIG. 20).

Then, the communications circuit (the communications portion 1026 of FIG. 19) incorporated in the residual ink materials cost refunding apparatus 1001C and not shown in FIG. 18 transfers the back points earned this time through the communications circuit (the communications unit 1045 of FIG. 19) incorporated in the cash register 1003 and not shown in FIG. 18 (step S350 of FIG. 20).

When the refund history information represents “written,” information that “the point processing has already been carried out” is displayed on the display 1013 (step S370 of FIG. 20).

When the cash register 1003 receives the back points earned this time, as shown in FIG. 21, a calculation program (the register calculating unit 1041 shown in FIG. 19) provided in the cash register 1003 subtracts the amount corresponding to the back points earned this time from the amount billed (step S410 of FIG. 21). For this reason, the register calculating unit 1041 also constitutes a part of the materials cost generating portion of the present invention. Then, the amount billed and the billing statement are displayed on the display 1033 (step S420 of FIG. 21), and information that the amount corresponding to the back points earned this time is subtracted for settlement of accounts is transmitted to the residual ink materials cost refunding apparatus 1001C. (step S430 of FIG. 21).

Receiving this, the residual ink materials cost refunding apparatus 1001C rewrites the refund history information in the cartridge information in the IC memory 1081 to the one representative of “written” (step S360 of FIG. 20).

According to the present embodiment described above in detail, back points (materials cost) corresponding to the residual amount of ink are generated based on the ink residual amount data representative of the amount of ink not used in actual printing, the discount amount corresponding to the back points is calculated, and the discount amount is subtracted from the amount billed. That is, a refund is made to the user as the discount amount. Consequently, user dissatisfaction with the amount of residual ink that cannot be completely used can be resolved. Moreover, since “written” is written into the IC memory 1081 after the point data is written, there is no possibility that the ink residual amount data is read out from the IC memory 1081 more than once, so that there is no possibility that the materials cost is paid more than once.

While the residual amount of ink is treated as the amount of ink not used in actual printing in the present embodiment, the amount of ink used for maintenance may be treated as the amount of ink not used in actual printing as well as the residual amount of ink like in the first and the second embodiments so that the amount is also converted to points for which a refund is made to the user.

[Sixth Embodiment]

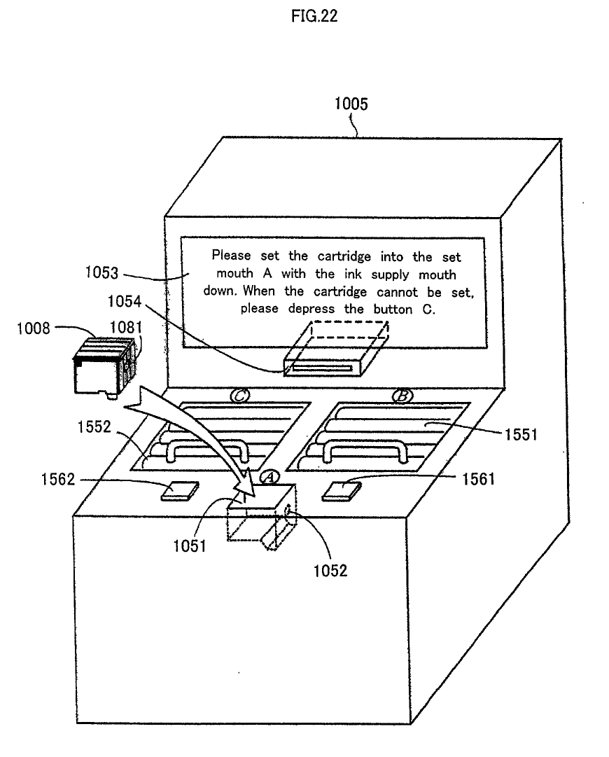

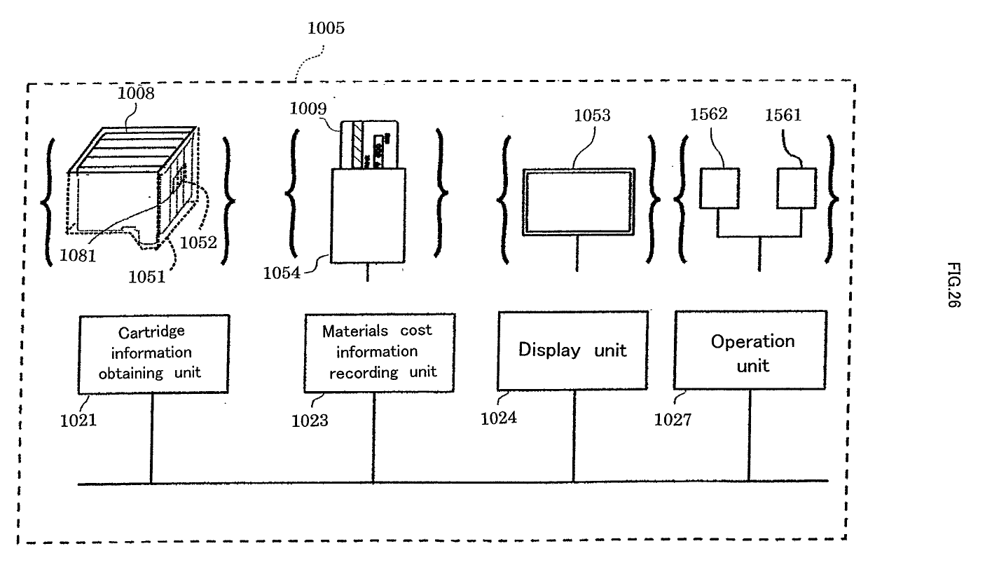

FIG. 22 through FIG. 25, FIG. 26 and FIG. 27 through FIG. 29 are explanatory views of a cartridge collecting apparatus with a materials cost refunding function according to the present embodiment. The present embodiment is an example of the coloring agent cartridge collecting apparatus of the present invention. In the present embodiment, as shown in FIG. 22 through FIG. 25, the cartridge collecting apparatus 1005 with a materials cost refunding function has a cartridge set portion (set portion 1051), a contact terminal portion 1052, a display portion 1053, a point card reading/writing portion (the materials cost recording portion of the present invention) 1054, a first collection box B, a second collection box C (here, shutters 1551 and 1552 are provided), a first lamp button switch 1561 and a second lamp button switch 1562. In the present embodiment, two boxes are provided for collecting ink cartridges by type.

Like the ink cartridge 1008 shown in FIG. 11, the ink cartridge 1008 used in the present embodiment is provided with the IC memory 1081 capable of recording the residual amount of ink, and has ink tanks of inks of a plurality of colors (ink tanks 1821 through 1824 of four colors shown in FIG. 11.

The contact terminal portion 1052 is formed on an inner side surface of the set portion 1051. When the ink cartridge 1008 fit for the set portion 1051 is set in the set portion 1051, the IC memory 1081 is in contact with the contact terminal portion 1052 and can read out the residual ink amount data recorded in the IC memory 1081.

On the display portion 1053, various items such as back points and operation instructions to the user are displayed. The point card reading/writing portion 1054 is capable of reading out user information, point information and the like from the point card 1009 and newly writing point information and the like onto the point card 1009.

The shutter 1551 of the first collection box B can be opened and closed with the first lamp button switch 1561 only when the switch 1561 is lit. The shutter 1552 of the second collection box C can be opened with the second lamp button switch 1562 both when the switch 1562 is lit and not lit. Moreover, the shutter 1552 of the second collection box C can be closed with the second lamp button switch 1562 only when the switch 1562 is lit.

FIG. 26 is a view showing the internal structure of the cartridge collecting apparatus 1005 with a materials cost refunding function. In FIG. 26, the cartridge collecting apparatus 1005 with a materials cost refunding function comprises an information reading unit 1021, a materials cost recording unit 1023, a display unit 1024 and an operation unit 1027. In FIG. 26, for ease of understanding of the present embodiment, for the units 1021, 1023, 1024 and 1025, correspondence with the elements shown in FIG. 22 through FIG. 25 is shown in the parentheses.

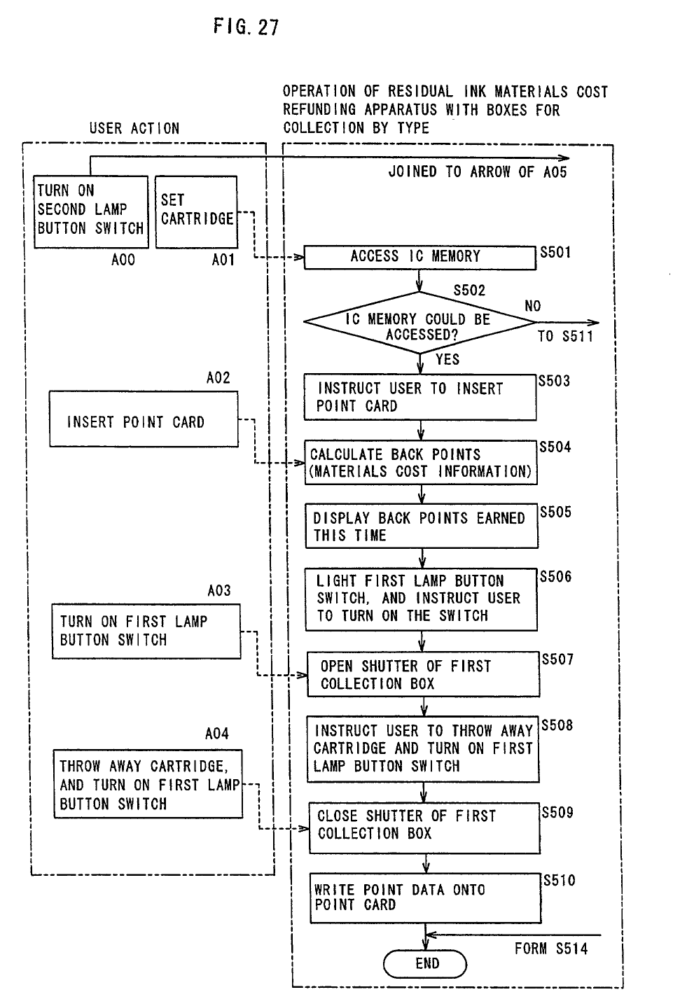

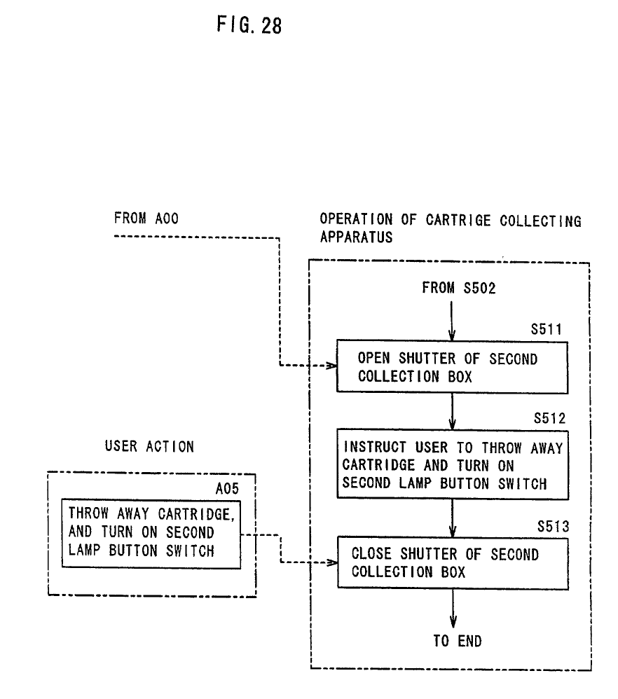

Now, the operation of the cartridge collecting apparatus 1005 with a materials cost refunding function will be described with reference to the explanation views of FIG. 22 through FIG. 25 and the flowcharts of FIG. 27 and FIG. 28.

When ink cartridge 1008 is not set in the set portion 1051, as shown in FIG. 22, a message “Please set the cartridge into the set mouth A with the ink supply mouth down. When the cartridge cannot be set, please depress the button C” is displayed on the display 1053.

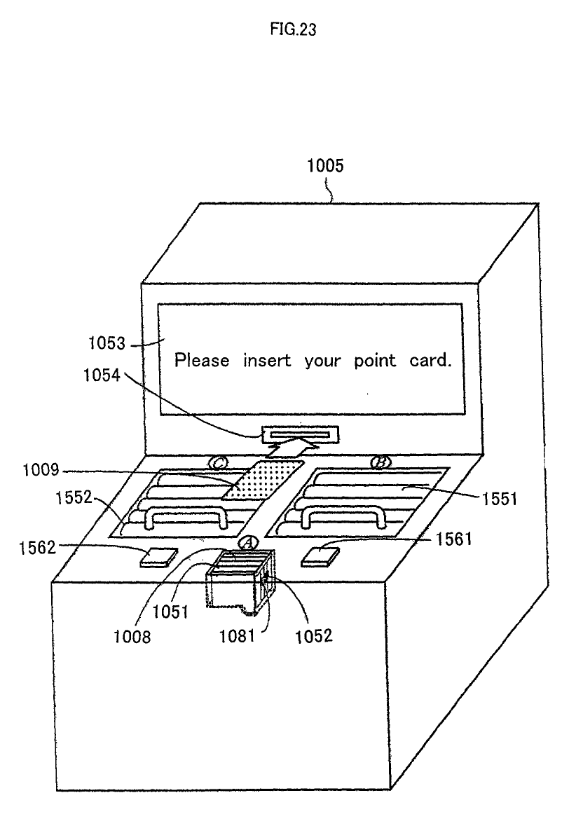

When the user sets the ink cartridge 1008 into the set portion 1051 as shown in FIG. 23 in response to the message (user action A01), access to the IC memory 1081 is made (S501).

When this access is made, a non-illustrated cartridge data reading circuit reads out cartridge data C_DATA from the IC memory 1081, and outputs back point information BP_INF and maker information MAKER_INF to a non—illustrated CPU.

That is, first, it is determined whether the access to the IC memory 1081 can be made or not (S502), and when the access can be made, a message “Please insert your point card” prompting the user to insert the point card 1009 is displayed on the display portion 1053 (S503). When the user inserts the point card 1009 into the point card reading/writing portion 1054 (user action A02), the back points (materials cost information) are calculated (S504), the back points earned this time are displayed (S505), the first lamp button switch 1561 is lit, and the user is instructed to turn on the switch 1561 (S506).

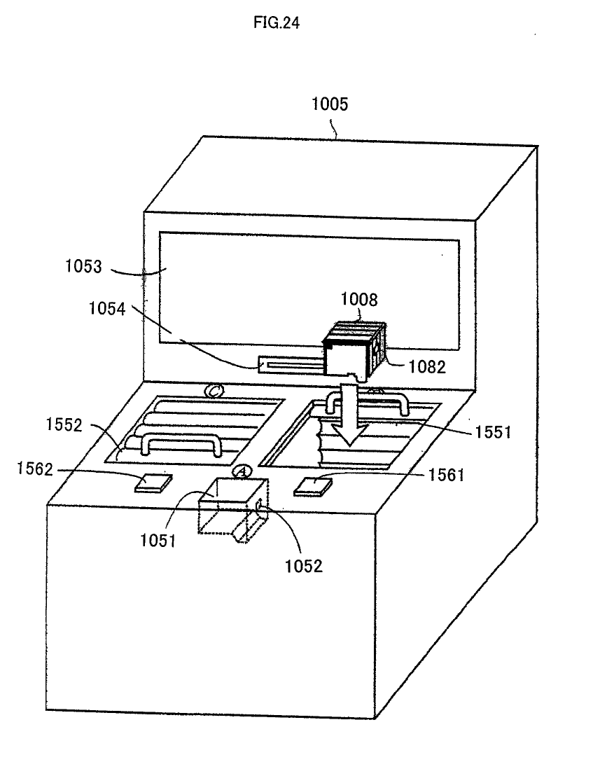

Then, when the user turns on the first lamp button switch 1561 (user action A03), as shown in FIG. 24, the shutter 1551 of the first collection box B is opened (S507). Then, a message “Please take out the cartridge from the set mouth A, put it in the collection box B, and depress the button B” instructing the user to throw away the ink cartridge 1008 and prompting the user to turn on the first lamp button switch 1561 is displayed on the display portion 1053 (S508).

Then, when the user throws away the cartridge 1008 and turns on the first lamp button switch 1561 (user action A04), the shutter 1551 of the first collection box B is closed (S509), and the point data is written onto the point card 1009 (S510).

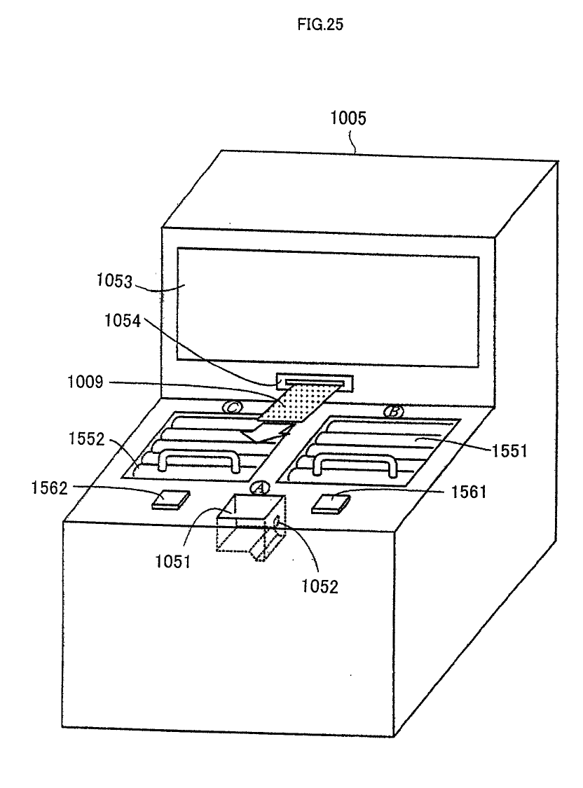

Then, as shown in FIG. 25, a message “Please take out the point card. The back points earned this time: xxx. The total back points: yyy. Thank you” is displayed on the display portion 1053.

On the other hand, when the user cannot set the cartridge 1008 into the set portion 1051, the user turns on the second lamp button switch 1562 in response to the display on the display portion 1053 shown in FIG. 22 (user action A00). Then, the shutter 1552 of the second collection box C is opened (S511). Moreover, when the access to the IC memory 1081 cannot be made at the above-described step S502, the shutter 1552 of the second collection box C is also opened (S511). Then, although not shown, a message to instruct the user to throw away the cartridge 1008 and turn on the second lamp button switch 1562 is displayed on the display portion 1053 (S512). When the user throws away the cartridge 1008 and turns on the second lamp button switch 1562 (useractionA05), the shutter 1552 of the second collection box C is closed (S513), and the processing is ended.

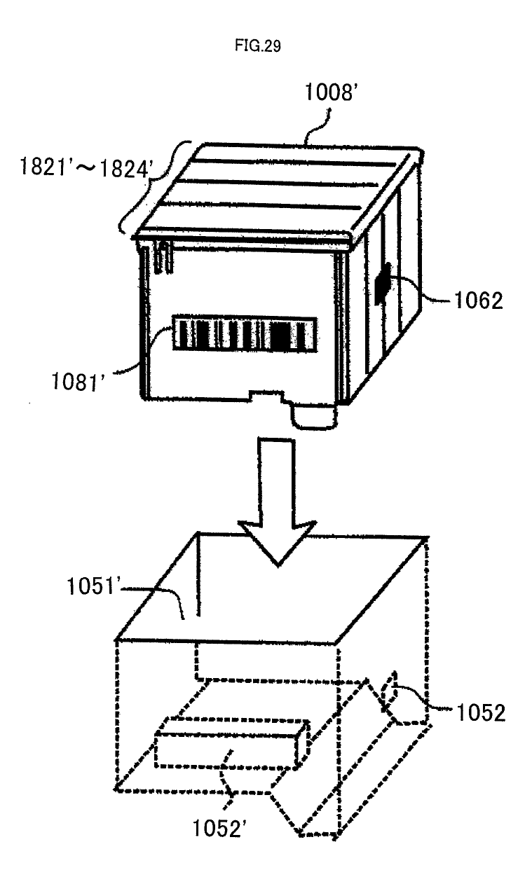

While the maker information MAKER_INF and the like are obtained from the IC memory 1081 in the present embodiment, the maker information and the like may be obtained by use of a different technique. For example, a bar code 1081′ representative of the maker information MAKER_INF and the like maybe provided on a cartridge 1008′ (comprising ink tanks 1821′ through 1824′) as shown in FIG. 29. In this case, a bar code reader 1052′ is provided in the cartridge set portion (set portion 1051′).

According to the present embodiment described above in detail, back points (materials cost) corresponding to the residual amount of ink are generated based on the ink residual amount data representative of the amount of ink not used in actual printing, and after the ink cartridge 1008 is thrown into the first collection box B, the back points earned this time are written onto the point card 1009. That is, a refund is made to the user as back points. Consequently, user dissatisfaction with the amount of residual ink that cannot be completely used can be resolved. Moreover, since “written” is written into the IC memory 1081 after the point data is written, there is no possibility that the ink residual amount data is read out from the IC memory 1081 more than once, so that there is no possibility that the materials cost is paid more than once. Further, since a refund is made to the user as back points, users will willingly return used ink cartridges 1008, so that the rate of returned used cartridges increases to improve recycling.

While the residual amount of ink is treated as the amount of ink not used in actual printing in the present embodiment, the amount of ink used for maintenance may be treated as the amount of ink not used in actual printing as well as the residual amount of ink like in the first and the second embodiments so that the amount is also converted to points for which a refund is made to the user.

[Seventh Embodiment]

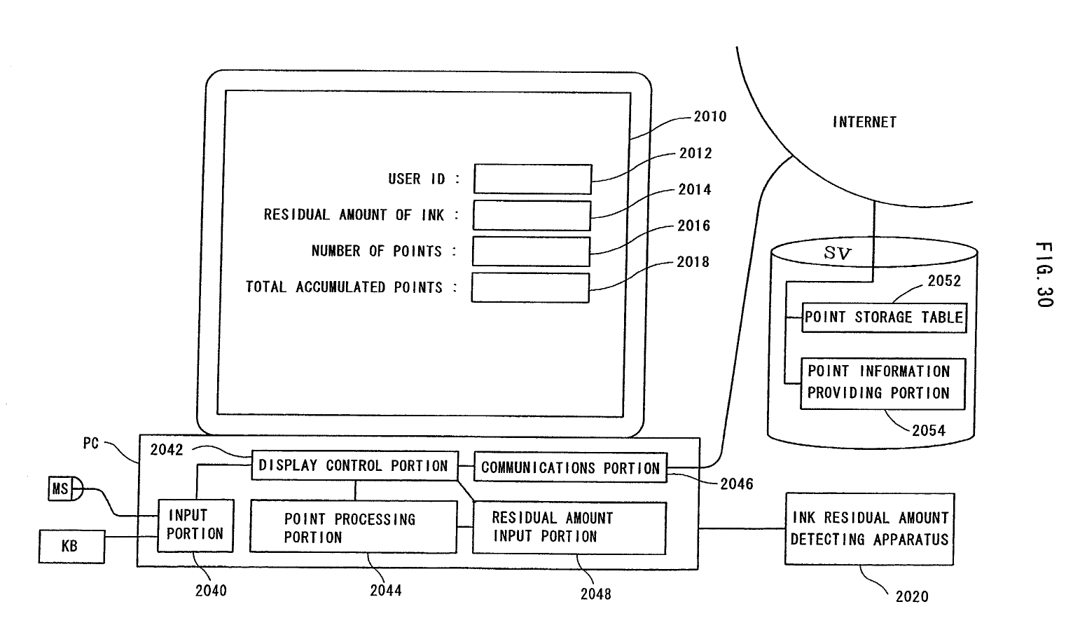

FIG. 30 is a block diagram showing the structure of an ink cartridge collecting system according to the present embodiment. Ink cartridges collected in the present embodiment are cartridges used for ink jet printers. The ink cartridge collecting system comprises a general-purpose personal computer PC, an ink residual amount detecting apparatus 2020, and a server SV connected to the personal computer PC through the Internet.

The personal computer PC is provided with: an input unit 2040 for inputting signals from a keyboard KB and a mouse MS; a residual amount input unit 2048 for inputting the ink residual amount data detected by the ink residual amount detecting apparatus 2020; a point processing unit 2044 converting the residual amount of ink to points exchangeable for bonuses and updating the total accumulated points; a communications unit 2046 performing communications with the server SV through the Internet; and a display control unit 2042 controlling signals and data from the input unit 2040, the residual amount input unit 2048, the point processing unit 2044 and the communications unit 2046, and displaying a user interface 2010. The personal computer PC is connected to the server SV through the Internet. The personal computer PC is also connected to the ink residual amount detecting apparatus 2020 detecting the residual amount of ink of the ink cartridge by a parallel or serial general-purpose cable.

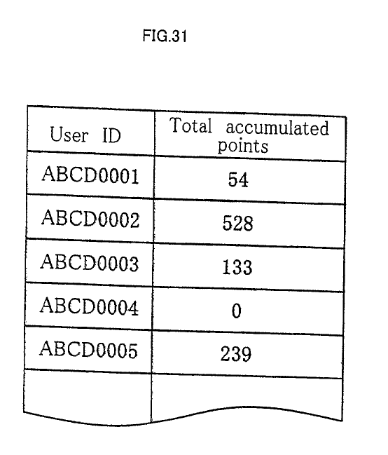

The server SV is provided with a point storage table 2052 and a point information providing unit 2054. FIG. 31 is an explanatory view showing the point storage table 2052. In the point storage table 2052, user IDs for identifying users and the accumulative totals of points corresponding to the accumulative residual amounts of ink of the ink cartridges returned from the users are stored so as to be associated with each other. The point information providing unit 2054 provides point information in a form such as the HTML (hyper text markup language) so that each user can view point information on a home page by use of a browser by inputting the individual user ID and establishing connection to the server SV through the Internet. The point information providing unit 2054 is also provided with a catalog of items for which the points are exchangeable. The exchange of points for items will be described later.

The ink residual amount detecting apparatus 2020 (FIG. 30) reads out the ink residual amount data from a storage element 2080 provided in a cartridge main body 2110 described later, and transfers the data to the personal computer PC.

The user interface 2010 is provided with: an identification information display portion 2012 for inputting user IDs; a residual amount display portion 2014 displaying the residual amount of ink detected by the ink residual amount detecting apparatus 2020; a point display portion 2016 displaying the points supplied in accordance with the residual amount of ink; and a total accumulated points display portion 2018 displaying the sum total of the past total accumulated points read out from the server SV and the points corresponding to the residual amount of ink detected by the ink residual amount detecting apparatus 2020.

While user IDs are input from the keyboard KB in the present embodiment, they may be input by preparing a card storing a user ID and reading the user ID from the card by use of a card reader.

For conversion from the residual amount of ink to points carried out by the point processing unit 2044, various methods are adoptable. For example, the rate of conversion from the residual amount of ink to points may be fixed to a predetermined value so that the relationship between the residual amount and the points is linear, or the rate of conversion may be stepped every predetermined residual amount. Moreover, the conversion rate may be varied among the kinds of ink.

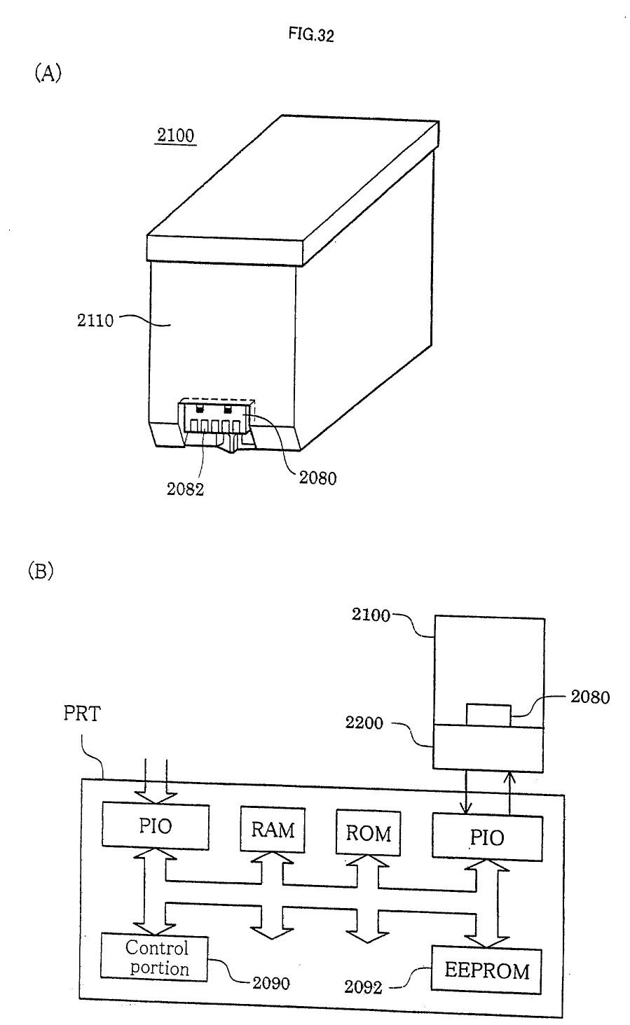

The ink cartridge to be collected in the present embodiment will be described. FIG. 32(A) and FIG. 32(B) are explanatory views for explaining a color ink cartridge 2100. FIG. 32(A) is a perspective view schematically showing the structure of the color ink cartridge 2100. FIG. 32(B) is a schematic block diagram of the color ink cartridge 2100 when it is mounted in an ink jet printer PRT.

Although not shown, the color ink cartridge 2100 integrally contains inks of five colors, cyan, light cyan, magenta, light magenta and yellow. The color ink cartridge 2100 is provided with a cartridge main body 2110 containing ink, and a storage element 2080 for storing data such as the ink residual amount data. When the storage element 2080 is attached to a carriage 2200 of the ink jet printer PRT, a plurality of connection terminals 2082 of the color ink cartridge 2100 is in contact with a plurality of non-illustrated connection terminals of the carriage 2200, and various kinds of data are exchanged with the ink jet printer PRT. When the storage element 2080 is used in this collecting system, the connection terminals 2082 are in contact with non-illustrated connection terminals of the ink residual amount detecting apparatus 2020 for use in the detection of the ink residual amount data.

The ink jet printer PRT is provided with a control portion 2090 comprising a CPU, a RAM, a ROM, a parallel input/output interface PIO and an EEPROM 2092. The various kinds of data read out from the storage element 2080 are stored into the EEPROM 2092. The control portion 2090 calculates the residual amount of ink from the ink residual amount data stored in the EEPROM 2092 and the amount of ink used for printing, and rewrites the ink residual amount data in the EEPROM 2092 and the storage element 2080.

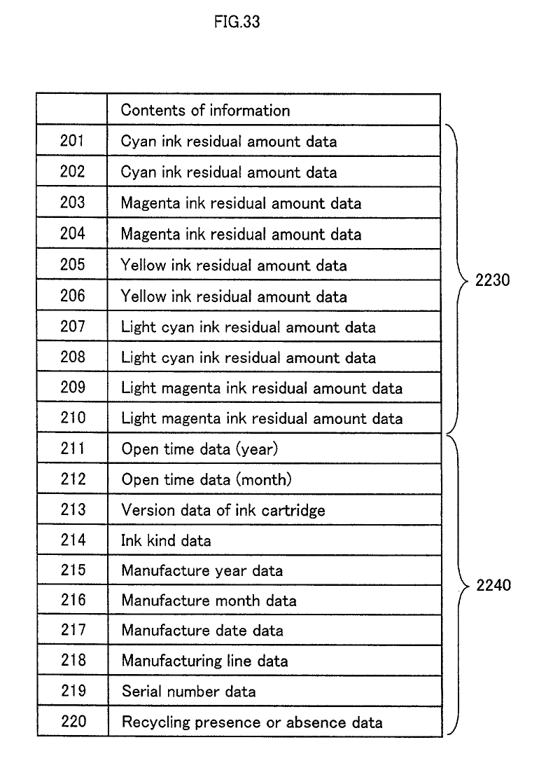

FIG. 33 is an explanatory view showing the data arrangement of the storage element 2080 provided in the color ink cartridge 2100. The memory cell of the storage element 2080 is provided with a first area 2240 storing read-only data and a second area 2230 storing rewritable data.

In the first area 2240, the following data are stored: open time data (year) of the color ink cartridge 2100; open time data (month) of the color ink cartridge 2100; version data of the color ink cartridge 2100; ink kind data representative of dye ink or pigment ink; manufacture year data of the color ink cartridge 2100; manufacture month data of the color ink cartridge 2100; manufacture date data of the color ink cartridge 2100; manufacturing line data of the color ink cartridge 2100; serial number data of the color ink cartridge 2100; and recycling presence or absence data representative of whether the cartridge main body 2110 is a new one or a recycled one. These are data read out by the ink jet printer PRT when the color ink cartridge 2100 is mounted in the ink jet printer PRT.

In the second area 2230, the following data are stored: cyan ink residual amount data; magenta ink residual amount data; yellow ink residual amount data; light cyan ink residual amount data; and light magenta ink residual amount data. Two storage areas are assigned to each ink residual amount data because rewriting is alternately carried out on these areas.

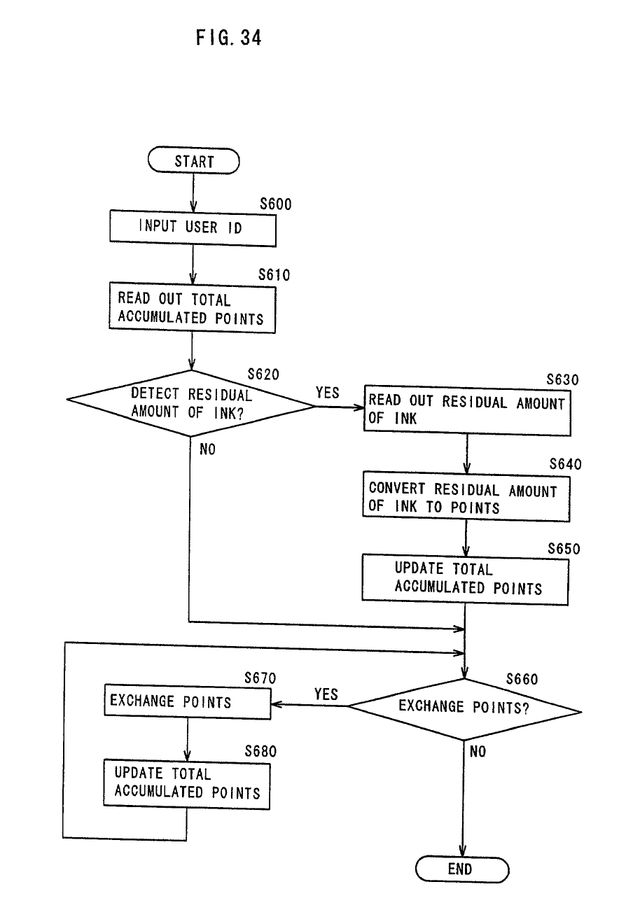

Next, a collecting processing of the present embodiment will be described. FIG. 34 is a flowchart of the detection of the residual amount of ink of the color ink cartridge 2100 and the point exchange. First, the user brings a used ink cartridge to a store where the ink residual amount detecting apparatus 2020 is placed. The store where the ink residual amount detecting apparatus 2020 is placed may be a personal computer shop handling consumable supplies for ink jet printers PRT or may be a so-called convenience store. Then, the user inputs the user ID to the personal computer PC of the ink cartridge collecting system (step S600). Then, the communications unit 2046 of the personal computer PC reads out the total accumulated points, earned up to that time, corresponding to the input user ID from the point storage table 2052 of the server SV through the Internet (step S610). Then, the user is prompted whether to detect the residual amount of ink or not (step S620). When the residual amount of ink is detected, the color ink cartridge 2100 is set in the ink residual amount detecting apparatus 2020, and the ink residual amount data stored in the second area 2230 of the storage element 2080 provided in the color ink cartridge 2100 is read out (step S630). The residual amount data read out by the ink residual amount detecting apparatus 2020 is converted to points by the point processing unit 2044 (step S640). Then, the points are added to the total accumulated points read out from the server SV, and the total accumulated points are updated (step S650). Then, a prompt as to whether to exchange points for an item or not is made (step S660). The user can exchange earned points for anew ink cartridge, a product such as ink jet printing paper, a discount coupon, cash or the like. When points are exchanged (step S670), the points corresponding to the item are subtracted from the total accumulated points, and the total accumulated points are updated (step S680). Then, a prompt as to whether to further exchange points or not is made (stepS660). When points are not exchanged, the process is ended. When points are further exchanged, steps S670 and S680 are repeated. When the residual amount of ink is not detected at step S620, the process proceeds to step S660 to make a prompt as to whether to exchange points or not, and the steps are carried out.

In this manner, the residual amount of ink is detected, and the color ink cartridge 2100 of which the residual amount of ink has been converted to points is collected. In order that the residual amount of ink of the color ink cartridge 2100 of which residual amount of ink has been detected once is not erroneously converted to points again, the ink residual amount detecting apparatus 2020 may rewrite the ink residual amount among data in the storage element 2080 to zero.

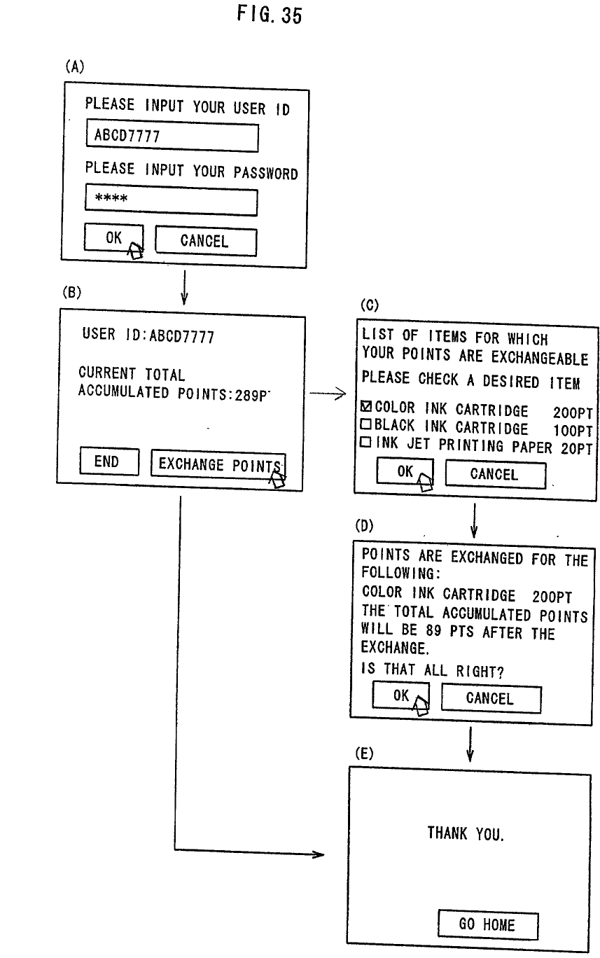

The user can view his/her own point information and exchange points by accessing the server SV through the Internet from the personal computer PC of the ink cartridge collecting system, a personal computer other than this, a cellular phone or an information terminal and inputting the user ID. FIG. 35 is an explanatory view showing an example of the flow of point information browsing and point exchange. This figure shows screens displayed on the monitor of the user's personal computer.

The user accesses the point storage table 2052 by inputting his/her own user ID and password on a Web page on the Internet provided by the point information providing unit 2054 of the server SV (FIG. 35(A)). Then, the current total accumulated points can be browsed (FIG. 35(B)). In FIG. 35(B), the user can make a selection between ending browsing and exchanging points. When the user clicks on the “Exchange points” button to select exchanging points, the current total accumulated points and a list of items for which the points are exchangeable are displayed, and a desired item is selected from the list (FIG. 35(C)). When the “End” button is clicked, a browsing end screen is displayed, and browsing is ended (FIG. 35(E)). When a desired item is checked and the “OK” button is clicked in FIG. 35(C), a point exchange confirmation screen is displayed (FIG. 35(D)). When the “OK” button is clicked in FIG. 35(D), a point exchange end screen is displayed, and the process is ended (FIG. 35(E)).

The desired item for which the points are exchanged will be sent to the registered address at a later date. Alternatively, the item may be sent to an address specified by the user.

Now, correspondence between the elements of the present embodiment and the present invention will be clarified. The ink jet print PRT of the present embodiment corresponds to the coloring agent amount recording apparatus of the present invention. The ink cartridge collecting system of the present embodiment corresponds to the coloring agent materials cost processing apparatus of the present invention. The ink residual amount detecting apparatus 2020 corresponds to the information reading portion. The point processing unit 2044 of the personal computer PC corresponds to the materials cost generating portion. The communications unit 2046 of the personal computer PC and the server SV correspond to the materials cost recording portion. The point storage table 2052 corresponds to the predetermined target of recording.

According to the ink cartridge collecting system of the present embodiment described above, a refund is made to the user for the points corresponding to the residual amount of ink of the used ink cartridge and the user can exchange the points for items, which motivates users to return used ink cartridges. On the other hand, since users willingly return used ink cartridges, makers can improve the rate of returned used ink cartridges and carry out recycling and waste processing, so that makers can contribute to environmental preservation.

While the residual amount of ink is treated as the amount of ink not used in actual printing in the above-described embodiment, the amount of ink used for maintenance may be treated as the amount of ink not used in actual printing as well as the residual amount of ink like in the first and the second embodiments so that the amount is also converted to points for which a refund is made to the user. Moreover, while the personal computer PC is provided with the point processing unit 2044 in above-described embodiment, the server SV may be provided with the point processing unit 2044.

[Eighth Embodiment]

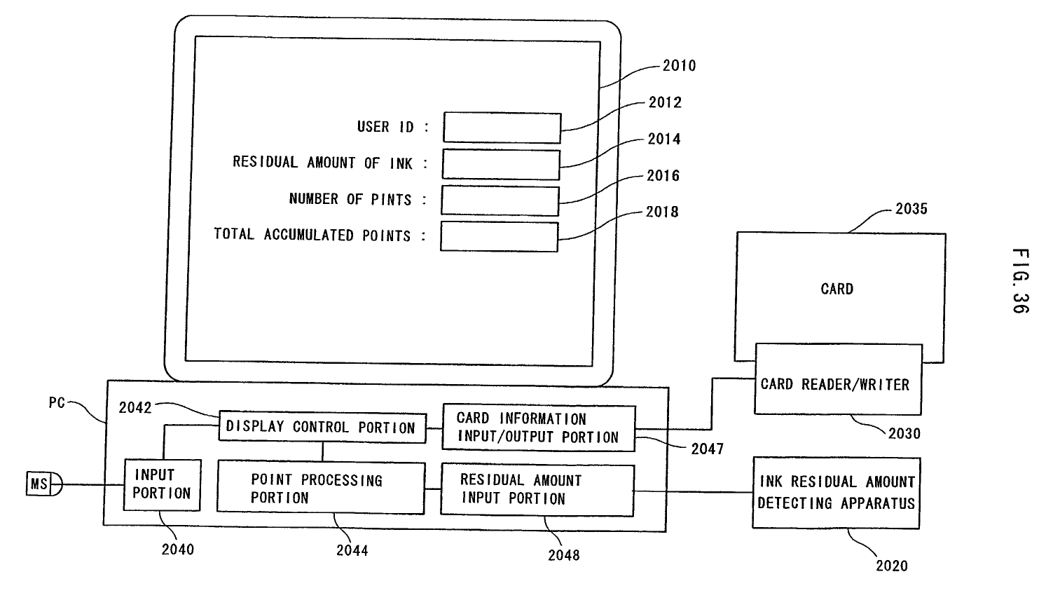

FIG. 36 is a block diagram showing the structure of an ink cartridge collecting system of the present embodiment. While in the seventh embodiment, the total accumulated points corresponding to the amount of collected ink is stored in the point storage table 2052 of the server SV so as to be associated with the user, in the present embodiment, the user ID and the total accumulated points are recorded on a card 2035 prepared for each user by use of a card reader/writer 2030. As the card 2035, a magnetic card or an IC card may be used. The personal computer PC is provided with a card information input/output portion 2047 instead of the communications unit 2046 of the seventh embodiment. Except for these, the structure is the same as that of the seventh embodiment. In the present embodiment, since point information is recorded on the card 2035, the point browsing and point exchange service by use of the Internet cannot be used. The present embodiment also improves the rate of returned used consumables like the seventh embodiment.

[Another Embodiment]

While ink cartridges are collected by users bringing ink cartridges to stores in the seventh and the eighth embodiments, they may be collected in the following manner: A collector or the like goes to the users home for collecting ink cartridges by transportation body such as a truck equipped with all or part of the ink cartridge collecting system of the present invention including the ink residual amount detecting apparatus 2020, and detects the residual amount of ink at the site.

What is claimed is:

1. A coloring agent amount recording apparatus recording an amount of a printing coloring agent, said apparatus comprising:
an information obtaining portion obtaining information on an amount of the printing coloring agent not used in actual printing; and
an information writing portion writing onto a recording medium the information on the amount obtained by said information obtaining portion.

2. A coloring agent amount recording apparatus according to claim 1,
wherein said recording medium is attached to a cartridge containing the printing coloring agent.

3. A coloring agent amount recording apparatus according to claim 1,
wherein said printing coloring agent is ink or toner.

4. A coloring agent amount recording apparatus according to claim 1,
wherein said amount not used in actual printing includes a residual amount of the printing coloring agent.

5. A coloring agent amount recording apparatus according to claim 1,
wherein said amount not used in actual printing includes an amount of the printing coloring agent used when maintenance of a printing mechanism is carried out.

6. A coloring agent amount recording apparatus according to claim 1,
wherein said information obtaining portion obtains the information on the amount not used in actual printing for each of the colors of the printing coloring agent, and
wherein said information writing portion writes onto the recording medium the information of each of the colors obtained by said information obtaining portion.

7. A coloring agent amount recording apparatus according to claim 1, said apparatus being a part of a printing apparatus carrying out printing with the printing coloring agent.

8. A coloring agent materials cost processing apparatus processing a materials cost of a printing coloring agent, said apparatus comprising:
an information reading portion reading out information on an amount of the printing coloring agent not used in actual printing from a recording medium on which the information on the amount is written; and
a materials cost generating portion generating a materials cost of the amount based on the information on the amount read out by said information reading portion.

9. A coloring agent materials cost processing apparatus according to claim 8,
wherein said materials cost generating portion writes onto the recording medium information representing that materials cost processing has been completed when the materials cost is refunded to a user.

10. A coloring agent materials cost processing apparatus according to claim 8, said apparatus comprising a materials cost recording portion recording the materials cost generated by said materials cost generating portion onto a predetermined target of recording.

11. A coloring agent materials cost processing apparatus according to claim 10,
wherein said materials cost recording portion records the materials cost onto the target of recording so as to be associated with a user.

12. A coloring agent materials cost processing apparatus according to claim 10,
wherein said materials cost recording portion records the materials cost onto the target of recording so as to be accumulated.

13. A coloring agent materials cost processing apparatus according to claim 10,
wherein said materials cost recording portion writes onto the recording medium information representing that materials cost processing has been completed when the materials cost is recorded onto the target of recording.

14. A coloring agent materials cost processing apparatus according to claim 10,
wherein said target of recording is a portable card-type memory.

15. A coloring agent materials cost processing apparatus according to claim 10,
wherein a storage content of said target of recording is accessible by a user through a network.

16. A coloring agent materials cost processing apparatus according to claim 8,
wherein said recording medium is attached to a coloring agent cartridge containing the printing coloring agent.

17. A coloring agent materials cost processing apparatus according to claim 8,
wherein said printing coloring agent is ink or toner.

18. A coloring agent materials cost processing apparatus according to claim 8,
wherein said amount not used in actual printing includes at least one of a residual amount of the printing coloring agent and an amount of the printing coloring agent used when maintenance of a printing mechanism is carried out.

19. A coloring agent materials cost processing apparatus according to claim 8,
wherein said materials cost is at least one selected from among the group consisting of a bonus to a user, a number of points analogous to cash, a voucher, a discount that the user receives when making a purchase, and a discount that the user receives when receiving a service.

20. A coloring agent materials cost processing apparatus according to claim 8,
wherein said information reading portion reads out, from a recording medium on which the information on the amount of the printing coloring agent not used in actual printing is written for each of the colors, the information on the amount of each of the colors; and
wherein said materials cost generating portion generates the materials cost based on the information on the amount of each of the colors read out by said information reading portion.

21. A coloring agent cartridge containing a printing coloring agent, said cartridge comprising a recording medium on which information on an amount of the printing coloring agent not used in actual printing is recorded.

22. A coloring agent cartridge collecting apparatus collecting a coloring agent cartridge, said apparatus comprising:
a coloring agent materials cost processing apparatus having an information reading portion reading out information on an amount of the printing coloring agent not used in actual printing from a recording medium on which the information on the amount is written, and a materials cost generating portion generating a materials cost of the amount based on the information on the amount read out by said information reading portion; and
a cartridge storage portion for collecting a coloring agent cartridge containing the printing coloring agent.

23. A transportation body for collection equipped with a coloring agent cartridge collecting apparatus,
wherein said coloring agent cartridge collecting apparatus comprising:
a coloring agent materials cost processing apparatus having an information reading portion reading out information on an amount of the printing coloring agent not used in actual printing from a recording medium on which the information on the amount is written, and a materials cost generating portion generating a materials cost of the amount based on the information on the amount read out by said information reading portion; and
a cartridge storage portion for collecting a coloring agent cartridge containing the printing coloring agent.

24. A method of collecting a coloring agent cartridge containing a printing coloring agent, said method comprising the step of:
(a) obtaining information on an amount of the printing coloring agent in the coloring agent cartridge, not used in actual printing; and
(b) generating a materials cost of the amount based on information on the amount.

25. A user interface used when a coloring agent cartridge containing a printing coloring agent is collected, said user interface comprising:
an identification information display portion for displaying identification information for identifying a user;
a materials cost display portion displaying a materials cost of an amount of the printing coloring agent not used in actual printing based on information on the amount; and
a materials cost accumulated total display portion displaying an accumulated total of the materials cost associated with the identification information.
